(19) United States
(12) Patent Application Publication
(10) Pub. No.: US 2025/0389588 A1
(43) Pub. Date: Dec. 25, 2025

(54) SYSTEM AND METHODS FOR COMPUTERIZED PHYSICAL MONITORING AND ASSESSMENTS

(71) Applicant: Delta Thermal, Inc., Tucson, AZ (US)

(72) Inventor: Andrew Griffis, Tucson, AZ (US)

(21) Appl. No.: 19/243,563

(22) Filed: Jun. 19, 2025

Related U.S. Application Data
(60) Provisional application No. 63/661,690, filed on Jun. 19, 2024.

(51) Int. Cl. G01J 5/02; G01J 5/00; G01J 5/48

(52) U.S. Cl. CPC G01J 5/0275; G01J 5/48; G01J 2005/0077

(57) ABSTRACT

A system and method for analyzing industrial environments through integrated multi-modal sensing, artificial intelligence, and automated deployment optimization. The system includes a dome base with multiple integrated sensors generating data streams from different sensing directions and sensor types. Machine learning workflows utilize multi-modal sensor fusion, computer vision algorithms, and predictive modeling techniques to transform reactive maintenance approaches into proactive, autonomous maintenance systems optimized for both technical performance and economic outcomes. The system includes mobile device integration capabilities for automated site analysis, equipment recognition, and sensor placement optimization using three-dimensional environmental mapping. Synthetic data generation enables customer demonstrations and system validation through simulated equipment behavior across operational and failure states. AI-driven sales automation generates technical proposals, cost-benefit analyses, and maintenance recommendations based on real-time sensor data and predictive modeling. Distributed intelligence architecture enables autonomous transaction processing, vendor management, and maintenance coordination throughout industrial maintenance ecosystems.

### CROSS-REFERENCE TO RELATED APPLICATIONS

This application is a non-provisional and claims benefit of U.S. Provisional Application No. 63/661,690 filed Jun. 19, 2024, the specification of which is incorporated herein in its entirety by reference.

The entire contents of U.S. Provisional Patent Application No. 63/013,081, filed Apr. 21, 2020, and U.S. patent application Ser. No. 16/779,622, filed Feb. 2, 2020, now U.S. Pat. No. 10,991,217 are hereby incorporated by reference.

### FIELD OF THE INVENTION

The present invention generally relates to sensor data collection and processing for safety and operational effectiveness, and to automated systems for optimizing the deployment, configuration, and commercial utilization of such sensor systems in industrial environments.

### BACKGROUND OF THE INVENTION

The world's infrastructure, e.g., power grids, mines, hospitals, stadiums, or anywhere using large, electrically powered tools, operates on switchgear technology. When switches fail, the collateral damage can be catastrophic. Some estimate that every year switchgear arc flash events cause 2,600 explosions, 7,000 burn injuries, and 400 deaths. Such events also produce significant downtime for equipment owners. These failures produce significant annual medical and parts costs for companies and even larger annual operational and revenue losses.

In the field of industrial thermography, the current standard practice is to use handheld devices to make image measurements and subsequently combine these image measurements with additional supporting physical measurements (e.g., atmospheric conditions for absorption). Sequences of manual operations are often combined with computer-assisted operations to produce reports corresponding to the point in time at which the handheld measurements were made. This is so, not only in the domain of electricity transmission and distribution but in other significant domains as well, e.g., oil and gas production and distribution and industrial equipment generally.

Thus, present-day practices for the measurement of the physical temperature of industrial equipment (for example, breakers, fuses, switches, and other circuit protection devices and components housed within a switchgear cabinet) often involve direct measurement using an instrument in contact with a region of the equipment, e.g., a bus bar connection fastener, and/or human measurement using a handheld thermographic device or the like, and may also include manual measurements and assessments of contributing factors. Contributing factors for handheld thermographic devices may include, for example, equipment optical properties, environmental properties, and sources of thermal energy other than the equipment being assessed. Such additional assessments are made to increase the accuracy of the equipment temperature reported by the handheld thermographic device.

Measuring with an instrument in contact with the equipment, e.g., a resistance temperature detector (RTD), thermistor, or thermocouple, often appears to be the least ambiguous method for measuring physical temperature. However, such an instrument measures only a single point of an object and does not provide information about the context of the measurement such that assessments of heat relative to a context could be made. Also, directly contacting an energetic surface, i.e., a highly energized electrical connection, can introduce risk to the instrument and the equipment. Further, in the event of an instrument failure, replacement can be cost-prohibitive when de-energizing critical (continuously operating) equipment is required to do so.

Such manual measurements can be valuable to the owners and operators of equipment, but often the equipment being assessed is in a dangerous area, e.g., highly energized electrical switchgear, or in a dangerous state, such as on the verge of overheating and igniting due to a loose bus bar connection. In a dangerous area, e.g., inside a cabinet housing electrical switchgear, safety protocols often prohibit making a manual measurement without first de-energizing the equipment. Since the equipment is often vital to some valuable process that requires continuous equipment operation, de-energizing is ill-advised for economic reasons. Further, even if there are occasional opportune times to de-energize and make a measurement, since underlying thermal processes for the measured equipment typically vary on a scale of minutes or hours, producing a single measurement on a yearly or even a monthly scale can lead to erroneous or misleading indicators of health and status.

At the same time, there is also a known risk of unintended intrusion, e.g., so-called “critter events,” at some equipment sites that endanger industrial assets. Consequently, it is advantageous to use both intrusion detection and thermography functions so as to minimize injury to equipment or humans who use or visit the equipment. Thus, there exists a present need for a system providing for a plurality of sensor modalities and back-end combination and analysis of said plurality of sensor modalities.

### BRIEF SUMMARY OF THE INVENTION

It is an objective of the present invention to provide systems that allow for sensor data collection and processing for safety and operational effectiveness, automated deployment optimization, and customer engagement capabilities, as specified in the independent claims. Embodiments of the invention are given in the dependent claims. Embodiments of the present invention can be freely combined with each other if they are not mutually exclusive.

For this disclosure, the term “dome” is defined as a surface that is not limited to planar geometry, but can have sections of its topography that are curvilinear or multi-faceted, such that sensing elements located thereon can have a non perpendicular orientation—the normal to the sensor is not parallel to the nominal surface normal. A common example is the simple hemispherical surface having the common name, dome, and this will be used as an easily understood example. However, the term “dome” is intended as a more general surface having one or more subsurfaces with distinct surface normals.

For this disclosure, “sensing element” is defined as what is often called a detector, whether photonic, electromagnetic, acoustic, or other modality is being detected, such detection representing the transformation of a physical observable into an electronic signal. Consequently, a sensing element (detector) will have accompanying components that help its efficiency and effectiveness, whether in the domain of power, impedance (coupling energy traversing air into a form suitable for the detector), digitization, or filtering/interpretation (machine learning) or interface and communication electronics.

The present invention features a system for analyzing an environment through multiple sensing modalities. The system may comprise a dome base and a plurality of sensors integrated into the dome base, each sensor configured to generate a data stream based on the environment. A plurality of sensing directions of the plurality of sensors may comprise a plurality of different directions. The plurality of sensors may comprise a plurality of sensor types. The system may further comprise a computing system communicatively coupled to the plurality of sensors. The computing system may comprise a machine learning model configured to accept a plurality of input data streams and generate a single operational health assessment of the environment as output. The machine learning model may be trained by a plurality of training data streams comprising one or more training data streams representing each sensor type of the plurality of sensor types. The computing system may be configured to accept, from the plurality of sensors, the plurality of data streams, input the plurality of data streams into the machine learning model, and generate, from the machine learning model, the single operational health assessment of the environment.

The present invention relates to systems and methods for measuring, assessing, predicting, improving, and presenting the state of physical object temperatures using imaging devices, e.g., a thermal infrared camera, and/or biological organisms, e.g., intruders or subjects, in a region of interest to an operator, such that little or no operator effort is required to use or receive reports from the system. Various embodiments of the invention are particularly useful for generating intuitive, real-time composite thermal images of heat-generating components within an enclosure, such as a switchgear cabinet or other enclosed space where thermal monitoring is inconvenient and/or dangerous. The present invention further relates to mobile device integration systems and methods for automated site analysis, system configuration optimization, and customer demonstration capabilities using synthetic data generation, such that deployment decisions and customer engagement can be optimized with minimal human intervention.

The present invention helps companies avoid that threat by continuously monitoring equipment in a form small enough to fit into confined spaces, e.g., a switchgear cabinet, and by using software that analyzes thermal data and informs automation systems to prevent catastrophic events. This disclosure addresses concerns of the industrial setting imposed on the invention, e.g., limitations of architecture and data structure that are peculiar to the industrial setting, particularly in the modes of connectivity, communication, data storage, data organization, and the physical configurations and spaces of the domain of concern.

The present invention contains advanced technology for insertion into relatively old industrial settings, e.g., the so-called “installed base”, making use of protocols, devices, interfaces, and device packages that may not “fit” into the industrial context. The present invention features a system configured to enable modalities of communication, connectivity, data organization, data production, data storage, and physical configuration that are coherent with related aspects of existing industrial equipment so that the full value of the invention can be more easily realized by contemporary industrial users.

One of the unique and inventive technical features of the present invention is the implementation of multi sensor device (hereafter, sensor composite), comprising a plurality sensor primitives (SP), each SP having one of several different sensing modalities, each SP also having its own machine learning (ML) capacity, such capacity being structured such that, whether used individually or in an ensemble, an ML workflow can be supported to enable integral optimization over time for observing and predicting anomalies in the relevant physical observables. Since each SP may contain ML capacities, each SP will be able to provide data that can range from minimally processed (“raw”) data to highly filtered data (“AI ready” data structures), such that each sensing modality is optimized for powerful spatial interpretations of that modality for the context into which it is installed. For instance, if an acoustic SP is used, a plurality of these may be preprocessed in the SP in order to limit bandwidth and enable more effective aperture synthesis when combined across a plurality of such devices, whether that combining happens in local processing nodes or remote nodes spanning greater regions of regard.

The sensor composite comprises a plurality of different sensor types configured to feed directly into a community machine learning algorithm configured to generate a single operational health assessment for the system. Without wishing to limit the invention to any theory or mechanism, it is believed that the technical features of the present invention advantageously provide for efficient analysis of an environment containing failure- and danger-prone equipment in order to generate useful insights such as optimal sensor placement, proposed improvements to equipment and configurations, simulations, and customer engagement tools. None of the presently known prior references or works have the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A shows a block diagram illustrating an embodiment of the present invention for integrating incremental sensing modalities and ensembles of sensor primitives, or sensor composites, smart multi-sensor modules at increasing levels of sensor aggregation and areas of regard.

FIG. 1B shows a schematic diagram of the system of the present invention, illustrating in general the aggregation of sensor composites into a next higher level of integration or complexity.

FIG. 2 shows a block diagram illustrating an embodiment of a sensor primitive of the present invention.

FIGS. 3A-3B show illustrations of a sensor composite comprising a plurality of sensor primitives in a biomimetic configuration of the present invention.

FIG. 4 shows a three dimensional rendering of the schematic views of sensor composites shown in FIG. 3, in which a hemispherical surface has a variety of spatially separated sensor primitives located on it, enabling imaging of diverse lines of sight extending from the hemisphere and synthesis of spatial distributions of physical observables using combinations of point sensors, e.g., acoustic or radio frequency waves, electric or magnetic fields.

FIG. 5 shows a workflow diagram illustrating the mobile device site analysis and system configuration process, showing the integration of mobile device sensors, AI processing pipeline, and automated customer engagement capabilities that enable complete sales process automation within 15-20 minutes.

FIG. 6 shows an architectural diagram depicting the AI-driven maintenance ecosystem, illustrating multiple facility locations with distributed sensor domes, layered artificial intelligence processing, multi-agent coordination systems, external system integrations, and autonomous transaction processing capabilities.

FIG. 7 shows a technical diagram showing the sensor data flow and machine learning pipeline, illustrating multi-modal sensor inputs, data preprocessing and fusion, comprehensive machine learning model architecture, predictive analytics outputs, automated decision making, and continuous model training with performance feedback loops.

### DETAILED DESCRIPTION OF THE INVENTION

Following is a list of elements corresponding to a particular element referred to herein:
110 gateway component
111 gateway local data storage
112 gateway local computer
113 gateway interface component
114 gateway LAN/WAN network interface
115 gateway radio
116 gateway local sensors
120 first cloud server
121 first cloud remote server component
122 first cloud LAN/WAN network interface
123 first cloud remote data storage
130 second cloud server
131 cloud remote computer
132 second cloud LAN/WAN network interface
133 second cloud remote data storage
140 second multi-sensor device, a sensor composite
141 third multi-sensor device, a sensor composite
142 fourth multi-sensor device, a sensor composite
200 first multi-sensor device, a smart camera
201 sensor local computer
202 non-thermal imager
203 thermal infrared camera
204 power conditioning component
205 environment, orientation, and geographic information system sensor
206 sensor interface component
207 sensor local data storage
208 acoustic radiofrequency source
209 acoustic sensor
400 sensor composite
401 sensor primitive with curved surface
402 sensor primitive with planar surface
500 mobile site analysis
501 site data capture
502 AI processing pipeline
503 customer engagement
504 complete sales process
600 AI-driven maintenance ecosystem architecture
601 manufacturing facility
602 power generation facility
603 data center
604 external system integration
605 distributed AI layers
606 autonomous transaction processing ecosystem
700 sensor data flow and machine learning
701 multi-modal sensor inputs
702 data preprocessing
703 machine learning models
704 predictive analytics
705 automated decision making and action planning
706 continuous learning loop
707 key performance indicators
1000 sensor composite
1010 (sensor composite) dome base
1020 sensors
1030 computing system
1040 impedance matching interface
1050 digitizer
1060 compact machine learning instantiation, tinyML
1070 memory
1080 CPU enabled API
2000 system

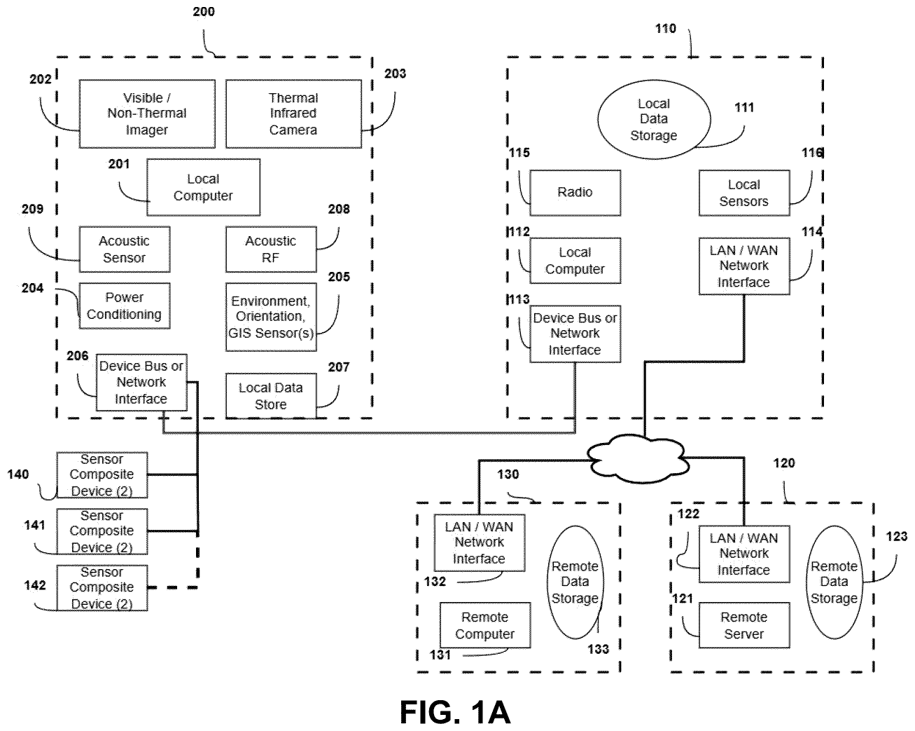

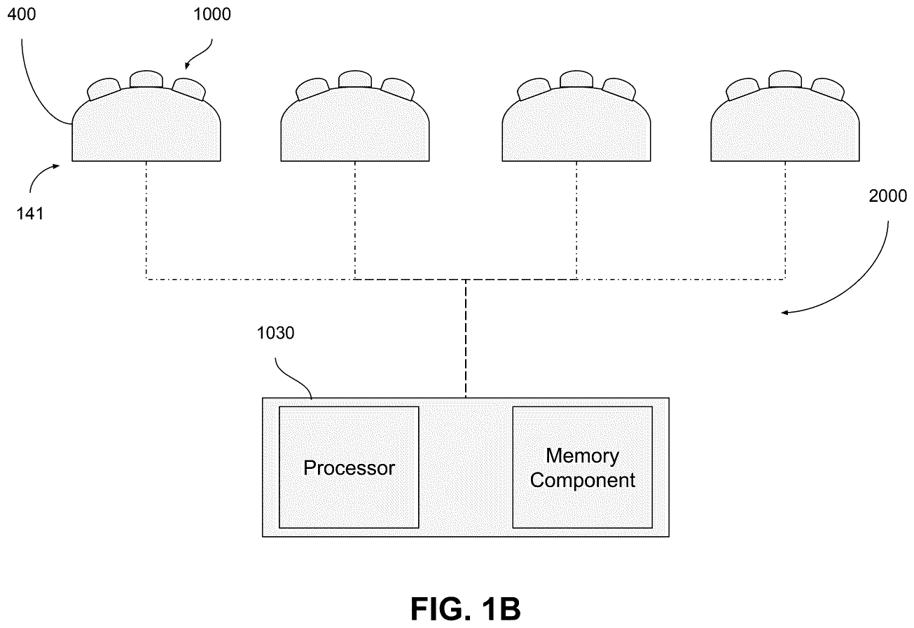

Referring now to FIG. 1A, the present invention features a system (2000) for analyzing an environment comprising one or more objects, one or more properties, or a combination thereof, through multiple sensing modalities and at increasing levels of computational complexity and spatial expanse as sensory data are progressively processed. The system (2000) may further comprise one or more sensor composites (140, 141, 142), a multi-sensor smart camera (200) capable of functioning independently or in aggregation with sensor composites. The system (2000) may further comprise a multi sensor smart camera (200) constituting a computing system by virtue of its Local Computer (201) communicatively coupled to the one or more sensor composites, comprising a processor configured to execute computer-readable instructions, and a memory component operatively coupled to the processor. The memory component may comprise a machine learning model configured to accept a plurality of input data streams and generate a single operational health assessment of the environment as output. The machine learning model may be trained by a plurality of training data streams comprising one or more training data streams representing each sensor type of the plurality of sensor types. The memory component may further comprise computer-readable instructions for accepting, from the plurality of sensor composites (400), the plurality of multi sensory data streams, inputting the plurality of data streams into the machine learning model, and generating, from the machine learning model, the single operational health assessment of the environment

The system (2000) may further comprise a gateway (110) having Local Computer (112) resource communicatively coupled to the one or more sensor composites (400), a multi sensor smart camera (200) or both, comprising a processor configured to execute computer-readable instructions, and a memory component operatively coupled to the processor. The memory component may comprise a machine learning model configured to accept a plurality of input data streams and generate a single operational health assessment of the environment as output. The machine learning model may be trained by a plurality of training data streams comprising one or more training data streams representing each sensor type of the plurality of sensor types. The memory component may further comprise computer-readable instructions for accepting, from the plurality of sensor composites (400) or smart cameras (200), the plurality of multi sensory data streams having had the opportunity to be conditioned by machine learning processes constituted by prior available computational resources, whether in a sensor primitive (1000), a sensor composite (400), a smart camera (400), this plurality of data streams may be flowed into the machine learning model, and generate, from the machine learning model, the single operational health assessment of the environment for a wider area of regard than permitted by the streams of data considered in less aggregated form.

The plurality of multi sensory data streams and machine learning interpretations, e.g., furnished by successive machine learning work flows, may be further combined across multiple gateway (110) devices in a remote or cloud computer resource (120, 130) extending to a plurality of such cloud resources spanning increasing areas of regard or levels of machine learning interpretation as gateway devices and cloud resources are added.

In some embodiments, the computing system (201, 112, 131, 121) may further comprise a mobile device integration module comprising computer-readable instructions. The computer-readable instructions may comprise receiving environmental image data from a portable computing device configured to generate images of an environment. The computer-readable instructions may further comprise identifying one or more industrial equipment configurations in the environmental image data. The computer-readable instructions may further comprise generating one or more automated sensor placement recommendations based on the one or more industrial equipment configurations. In some embodiments, the mobile device integration module may further comprise computer-readable instructions for recognizing one or more equipment types based on the one or more industrial equipment configurations using computer vision algorithms. The computer-readable instructions may further comprise accessing one or more equipment databases comprising failure statistics, thermal characteristics, or a combination thereof for each equipment type of the one or more equipment types. The computer-readable instructions may further comprise identifying one or more critical monitoring points based on the failure statistics, the thermal characteristics, or the combination thereof for each equipment type of the one or more equipment types. The computer-readable instructions may further comprise optimizing the one or more automated sensor placement recommendations to maximize coverage of the one or more critical monitoring points.

In some embodiments, the computing system (201, 112, 131, 121) may further comprise a synthetic data generation module comprising computer-readable instructions. The computer-readable instructions may comprise generating one or more simulated sensor data streams based on the data stream. The data stream may comprise one or more equipment characteristics, one or more operational parameters, or a combination thereof. The computer-readable instructions may further comprise generating one or more interactive demonstrations of system capabilities based on the one or more simulated sensor data streams. The computer-readable instructions may further comprise providing one or more customer engagement tools for system evaluation prior to purchase of equipment. In some embodiments, the computer-readable instructions may further comprise simulating thermal imagery, temperature readings, acoustic signatures, vibration patterns, or a combination thereof corresponding to normal operational states, degraded equipment conditions, failure scenarios, or a combination thereof.

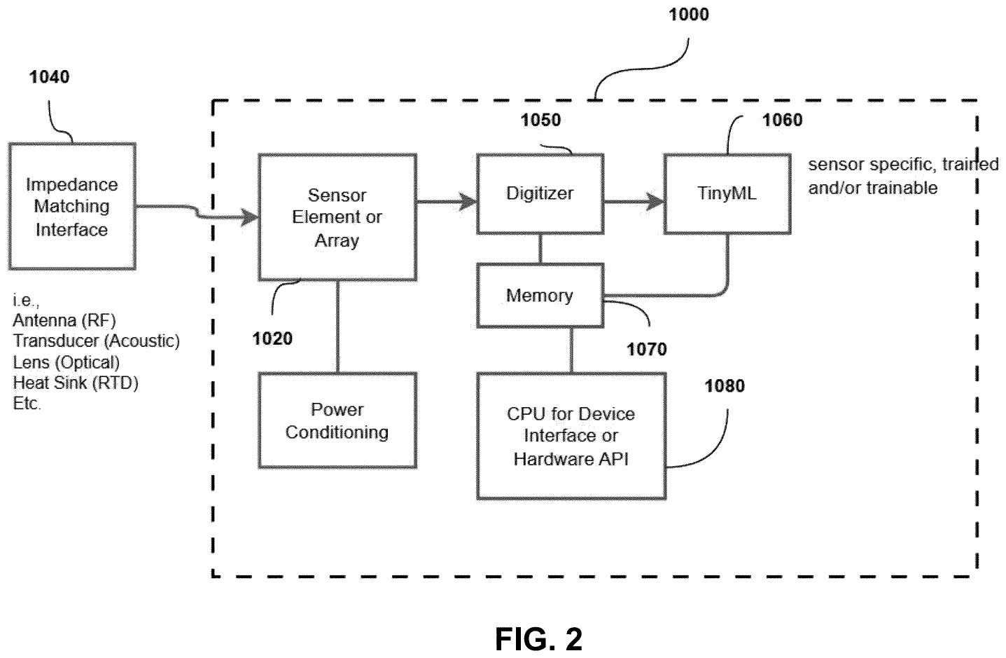

Referring now to FIG. 2, in some embodiments, each sensor primitive (1000) may comprise a sensor element or array of the same (1020) communicatively coupled to a digitizer having memory resources and connected to a compact machine learning resource (1060) e.g., TinyML, that furnishes machine learning streams to a memory resource (1070) such that a stream of machine learning sensory data is exposed through an embedded computer resource having a hardware or software application programming interface (API) (1080). In some embodiments, the sensor primitive sensor types may comprise visible sensors, thermal sensors, short-wave infrared sensors, long-wave infrared sensors, acoustic sensors, pressure sensors, temperature sensors, humidity sensors, range sensors, vibration sensors, two image sensors to produce range estimates using well known stereo imaging diversity equations, or a combination thereof.

Further referring to FIG. 2, it is often helpful to match the sensor element to its environment with an interface material or structure constituting an impedance matching interface (1040). In some embodiments this is constituted with a lens coupling light to a focal plane array, an antenna coupling waves to a radio frequency detector or a speaker cone coupling sound waves to an acoustic transducer.

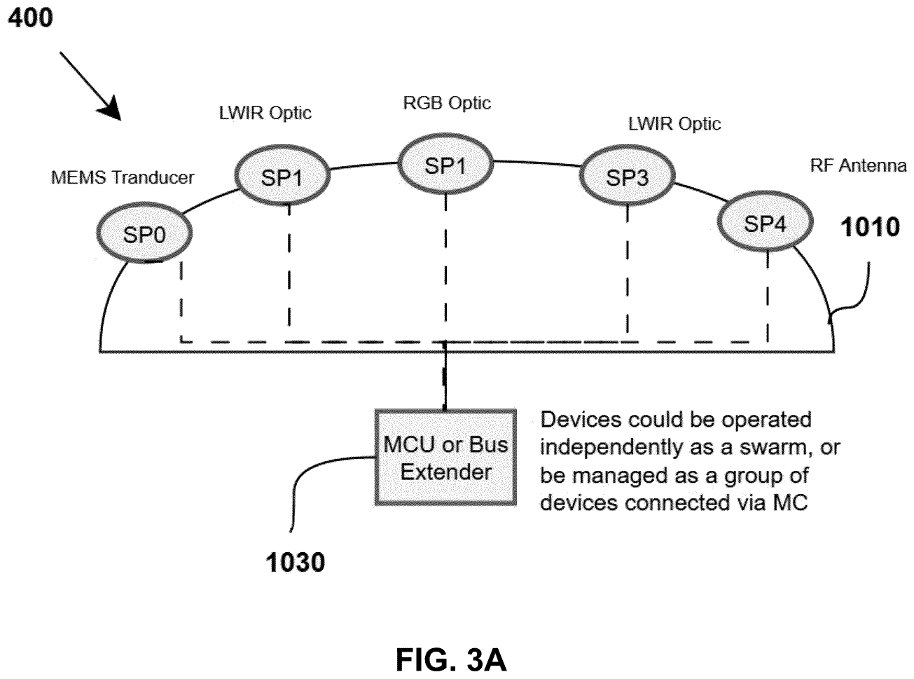

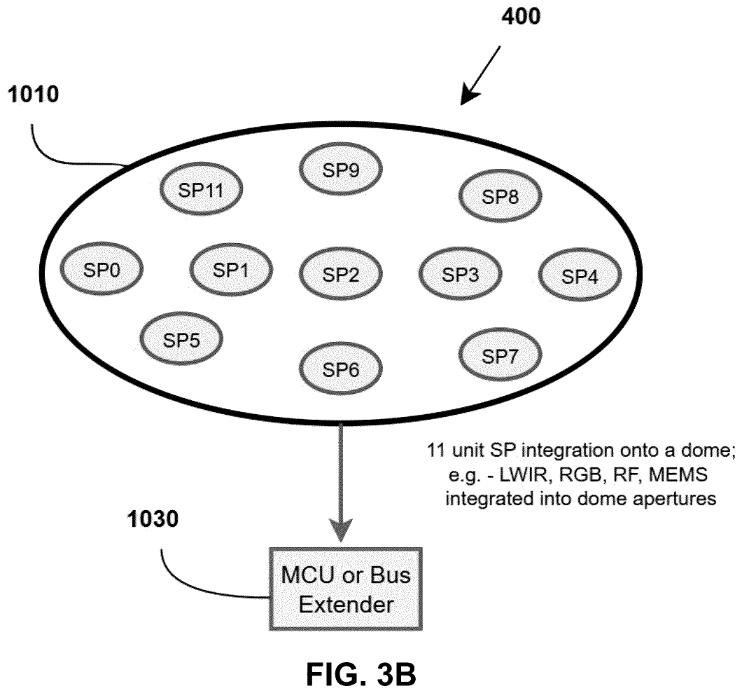

Referring now to FIG. 3, in some embodiments, each sensor composite (400) may comprise a dome base (1010). Each sensor composite (400) may further comprise a plurality of sensor primitives (1000) integrated into the dome base (1010), each sensor configured to generate a data stream based on the environment. A plurality of sensing directions of the plurality of sensor primitives (1000) may comprise a plurality of different directions. The plurality of sensor primitives (1000) may comprise a plurality of sensor types. The sensor composite (400) may further comprise a computing system (1030) communicatively coupled to the one or more sensor primitives, comprising a processor configured to execute computer-readable instructions, and a memory component operatively coupled to the processor. The memory component may comprise a machine learning model configured to accept a plurality of input data streams and generate a single operational health assessment of the environment as output. The machine learning model may be trained by a plurality of training data streams comprising one or more training data streams representing each sensor type of the plurality of sensor types. The memory component may further comprise computer-readable instructions for accepting, from the plurality of sensor primitives (1000), the plurality of data streams, inputting the plurality of data streams into the machine learning model, and generating, from the machine learning model, the single operational health assessment of the environment.

In some embodiments, the shape of the dome base may be configured to orient distributed sensor focal planes less obliquely such that radiometric and geometric performance is optimized, for instance such that the cos (theta) rolloff with angle is mitigated and spatial resolution (the mapping of angular resolution onto physical surface) is homogenized.

In some embodiments, the plurality of sensor primitives (1000) may comprise one or more planar sensors comprising curved optical components such that spherical aberrations of the one or more data streams of the one or more planar sensors are automatically corrected. In some embodiments, the memory component may further comprise instructions for stitching the plurality of data streams into a combined data stream. In some embodiments, the machine learning model may be further configured to accept the combined data stream as input and generate the single operational health assessment of the environment as output.

In some embodiments, inputting the plurality of data streams into the machine learning model may comprise individually inputting each data stream of the plurality of data streams into the machine learning model. In some embodiments, each sensor composite of the one or more sensor composites (140, 141, 142) may further comprise an impedance matching interface (1040) operatively coupled to each sensor primitive of the plurality of sensor primitives (1000), configured to individually control a power transfer of each sensor primitive of the plurality of sensor primitives (1000). In some embodiments, the computing system (1030) may further comprise a mobile device integration module comprising computer-readable instructions. The computer-readable instructions may comprise receiving environmental image data from a portable computing device configured to generate images of an environment. The computer-readable instructions may further comprise identifying one or more industrial equipment configurations in the environmental image data. The computer-readable instructions may further comprise generating one or more automated sensor placement recommendations based on the one or more industrial equipment configurations. In some embodiments, the mobile device integration module may further comprise computer-readable instructions for recognizing one or more equipment types based on the one or more industrial equipment configurations using computer vision algorithms. The computer-readable instructions may further comprise accessing one or more equipment databases comprising failure statistics, thermal characteristics, or a combination thereof for each equipment type of the one or more equipment types. The computer-readable instructions may further comprise identifying one or more critical monitoring points based on the failure statistics, the thermal characteristics, or the combination thereof for each equipment type of the one or more equipment types. The computer-readable instructions may further comprise optimizing the one or more automated sensor placement recommendations to maximize coverage of the one or more critical monitoring points.

In some embodiments, the computing system (1030) may further comprise a synthetic data generation module comprising computer-readable instructions. The computer-readable instructions may comprise generating one or more simulated sensor data streams based on the data stream. The data stream may comprise one or more equipment characteristics, one or more operational parameters, or a combination thereof. The computer-readable instructions may further comprise generating one or more interactive demonstrations of system capabilities based on the one or more simulated sensor data streams. The computer-readable instructions may further comprise providing one or more customer engagement tools for system evaluation prior to purchase of equipment. In some embodiments, the computer-readable instructions may further comprise simulating thermal imagery, temperature readings, acoustic signatures, vibration patterns, or a combination thereof corresponding to normal operational states, degraded equipment conditions, failure scenarios, or a combination thereof.

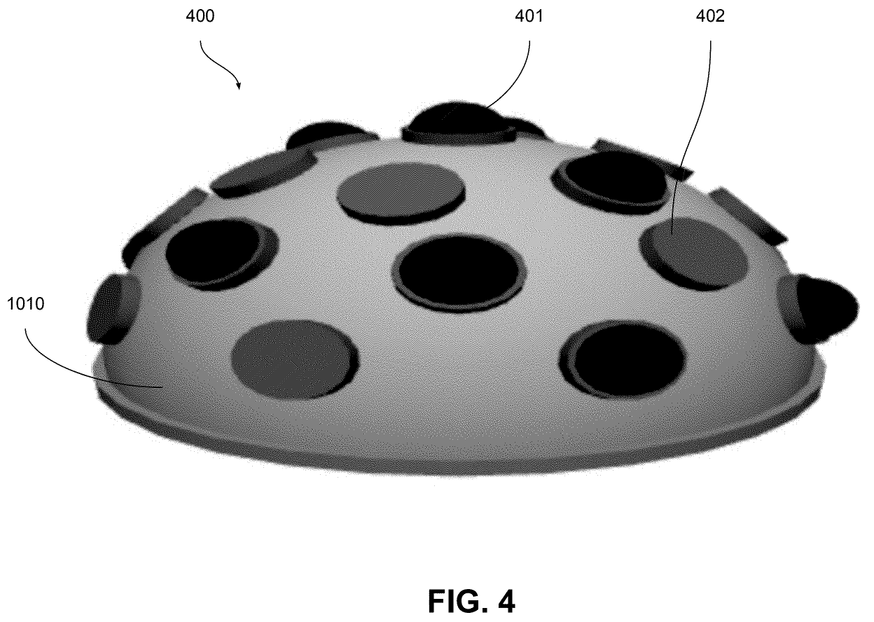

Referring to FIG. 4, the hemispherical surface (1010) of the sensor composite (400) is covered with a plurality of sensor primitives (401,402) (SP) representing many modalities of sensing, some with planar surfaces (401) such as would be appropriate to radio frequency antenna or an acoustic transducer and some with curved surfaces (402) such as would be required for a lens focusing energy on a focal plane array located behind it.

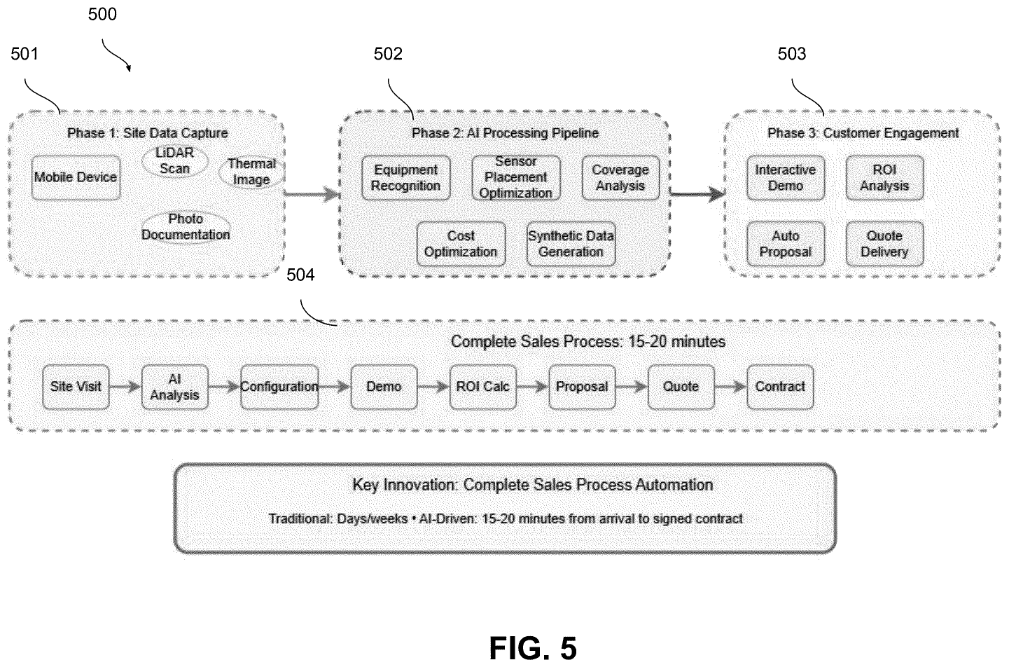

Referring to FIG. 5, the mobile device site analysis and system configuration workflow (500) demonstrates the integration of mobile computing devices with artificial intelligence processing to achieve complete sales process automation. The workflow comprises three primary phases that transform traditional manual site assessment and proposal generation into an automated, intelligent system capable of completing the entire sales cycle from initial site visit, through a simulated installation and user experience to signed contract within 15-20 minutes.

Phase 1 (501) encompasses site data capture utilizing mobile devices equipped with multiple sensing modalities. The mobile device, which may comprise a smartphone, tablet, or specialized handheld computing device, integrates LiDAR scanning capabilities for three-dimensional spatial mapping, thermal imaging sensors for equipment temperature assessment, and photographic documentation systems for visual equipment identification. The LiDAR scanning component generates precise three-dimensional point cloud data representing the spatial configuration of industrial equipment, electrical panels, and infrastructure components within the monitoring environment. Thermal imaging capabilities enable immediate identification of existing hot spots, temperature gradients, and thermal signatures that inform sensor placement optimization and risk assessment algorithms. Photographic documentation provides visual context and enables computer vision algorithms to identify equipment types, manufacturers, model numbers, and configuration details essential for automated system design.

Phase 2 (502) implements an comprehensive AI processing pipeline that transforms captured site data into optimized system configurations and customer-ready proposals. Equipment recognition and classification algorithms utilize computer vision techniques, including convolutional neural networks and object detection models, to automatically identify switchgear types, electrical panel configurations, transformer installations, and associated infrastructure components from captured imagery and spatial data. The system cross-references identified equipment against comprehensive databases of equipment specifications, typical failure modes, maintenance requirements, and optimal monitoring strategies to generate baseline monitoring recommendations.

Sensor placement optimization algorithms process three-dimensional spatial data to determine optimal positions for sensor dome installations that maximize coverage of critical thermal monitoring points while minimizing system cost and installation complexity. The optimization process considers line-of-sight requirements between sensors and monitoring targets, accessibility for maintenance personnel, power supply availability, communication network topology, and integration requirements with existing building management systems. Multi-objective optimization techniques balance competing objectives including coverage maximization, cost minimization, and installation complexity reduction to generate multiple configuration alternatives with associated performance and cost metrics.

Coverage analysis and risk assessment algorithms evaluate proposed sensor configurations against known equipment failure statistics and thermal behavior models to quantify monitoring effectiveness and potential risk reduction. The system calculates coverage percentages for critical monitoring points, identifies potential blind spots or coverage gaps, and provides probabilistic assessments of failure detection capabilities based on historical failure data and sensor performance characteristics.

Cost optimization algorithms dynamically adjust system configurations based on real-time component pricing, installation labor estimates, and customer-specific budget constraints. The system maintains databases of current component costs, supplier pricing, installation labor rates, and project complexity factors to generate accurate cost estimates and identify opportunities for cost reduction through alternative configurations or component selections.

Synthetic data generation capabilities create realistic simulated sensor data streams that demonstrate system capabilities to prospective customers without requiring actual sensor installation. Generative adversarial networks and physics-based modeling techniques produce synthetic thermal imagery, acoustic signatures, vibration patterns, and environmental data that accurately represent expected sensor outputs under various operational and failure scenarios. This synthetic data enables interactive customer demonstrations that show exactly how proposed monitoring systems would detect equipment anomalies, generate maintenance alerts, and provide operational insights.

Phase 3 (503) encompasses customer engagement and automated transaction processing that transforms AI-generated technical analyses into customer-ready proposals and contracts. Interactive demonstration systems present synthetic sensor data through user interfaces that simulate actual monitoring dashboards, allowing customers to explore system capabilities and understand the value proposition through hands-on experience. Customers can manipulate simulation parameters to observe system responses to different failure scenarios, seasonal variations, and operational conditions, providing confidence in system capabilities prior to purchase commitment.

Return on investment analysis algorithms automatically calculate projected cost savings, downtime reduction, maintenance optimization benefits, and total cost of ownership based on customer-specific operational parameters and historical industry data. The system quantifies potential benefits including prevention of catastrophic failures, reduction in emergency maintenance events, optimization of maintenance scheduling, and extension of equipment operational life through proactive monitoring and maintenance.

Automated proposal generation systems create comprehensive technical proposals including detailed system specifications, installation procedures, integration requirements, performance guarantees, and maintenance contracts. Natural language processing algorithms generate customer-specific technical documentation that addresses site-specific requirements, regulatory compliance needs, and integration with existing operational procedures. Dynamic pricing optimization ensures competitive pricing while maintaining target profit margins based on current market conditions, customer-specific risk assessments, and project complexity factors.

The complete workflow (504) transforms traditional sales processes that typically require multiple site visits, manual analysis, offline proposal preparation, and extended negotiation cycles into a streamlined automated process that delivers superior technical solutions with enhanced customer experience and dramatically reduced sales cycle times.

Referring now to FIG. 5, the present invention features a method for automated industrial monitoring system deployment. In some embodiments, the method may comprise capturing environmental data of an industrial site using a portable computing device. The method may further comprise processing the environmental data to identify, for one or more equipment modules, a location and a configuration. The method may further comprise automatically generating one or more optimal sensor placement recommendations based on the location and the configuration of the one or more equipment modules. The method may further comprise creating one or more synthetic sensor data streams for demonstration purposes. The method may further comprise generating one or more automated proposals comprising system specifications and cost analyses relative to the one or more equipment modules. In some embodiments, the method may further comprise optimizing sensor placement based on line-of-sight requirements, thermal monitoring coverage areas, accessibility for maintenance, power supply requirements, communication network topology, or a combination thereof.

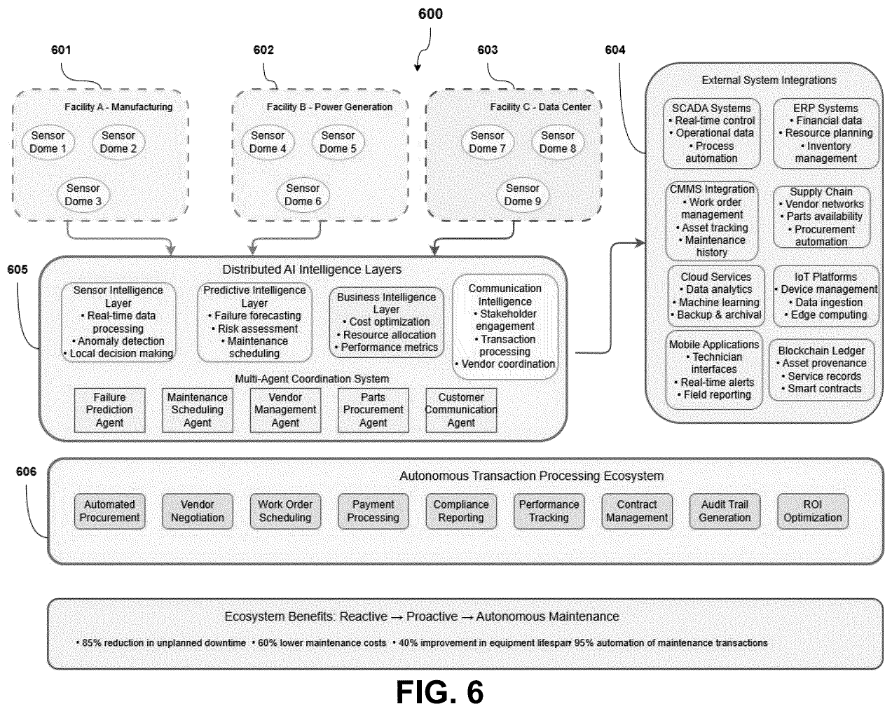

Referring to FIG. 6, the AI-driven maintenance ecosystem architecture (600) illustrates the comprehensive distributed intelligence system that transforms traditional reactive maintenance approaches into autonomous, predictive maintenance ecosystems spanning multiple facilities and industrial environments. The architecture demonstrates how individual sensor surfaces, e.g., domes, integrate within broader enterprise-wide maintenance management systems to deliver unprecedented levels of automation, optimization, and operational intelligence.

The ecosystem architecture encompasses multiple facility locations, each representing different industrial environments including manufacturing facilities (601), power generation plants (602), and data centers (603). Each facility location contains multiple sensor dome installations strategically positioned to monitor critical equipment and infrastructure components. The distributed sensor network creates a comprehensive monitoring mesh that provides complete visibility into equipment health, operational performance, and environmental conditions across the entire enterprise.

Individual sensor domes within each facility continuously collect multi-modal sensor data including thermal imagery, vibration signatures, acoustic emissions, environmental conditions, and electromagnetic field measurements. The sensor data streams feed into a four-layer distributed artificial intelligence architecture (605) that processes information at multiple levels of abstraction and decision-making authority.

The sensor intelligence layer implements real-time data processing algorithms at the edge of the network, performing immediate anomaly detection, threshold monitoring, and local decision-making functions. Machine learning models deployed at the sensor level enable rapid response to critical conditions without requiring communication with centralized systems, ensuring continued operation even during network disruptions. Local processing capabilities include statistical analysis, pattern recognition, trend detection, and immediate alert generation for conditions requiring urgent attention.

The predictive intelligence layer aggregates sensor data across multiple devices and time periods to perform failure forecasting, risk assessment, and maintenance scheduling optimization. Advanced machine learning models including recurrent neural networks, survival analysis algorithms, and ensemble methods analyze historical equipment performance data, sensor trend information, and environmental factors to predict equipment failures with high accuracy and appropriate lead times. Risk assessment algorithms quantify failure probabilities, potential impact assessments, and recommended intervention timelines to optimize maintenance resource allocation.

The business intelligence layer integrates predictive analytics with operational and financial data to optimize maintenance strategies from economic and operational perspectives. Cost optimization algorithms consider factors including parts availability, labor costs, operational priorities, production schedules, and budget constraints to recommend maintenance strategies that minimize total cost of ownership while maintaining operational reliability. Performance metrics calculation and key performance indicator tracking enable continuous improvement of maintenance strategies and demonstrate quantifiable value delivery to stakeholders.

The communication intelligence layer manages stakeholder engagement, transaction processing, and vendor coordination functions that enable autonomous maintenance execution. Natural language processing capabilities generate automated communications with maintenance personnel, equipment vendors, parts suppliers, and operational stakeholders. Transaction processing systems automatically generate work orders, purchase orders, service requests, and vendor communications based on predictive analytics and business rules.

Multi-agent coordination systems implement specialized artificial intelligence agents that manage specific aspects of maintenance operations. Failure prediction agents continuously monitor equipment health indicators and generate probabilistic failure forecasts. Maintenance scheduling agents optimize work order timing, resource allocation, and personnel assignments to minimize operational disruption while ensuring critical maintenance tasks receive appropriate priority. Vendor management agents maintain relationships with approved suppliers, monitor vendor performance, negotiate pricing, and coordinate service delivery. Parts procurement agents monitor inventory levels, predict parts requirements based on failure forecasts, and automatically initiate procurement processes to ensure parts availability when needed. Customer communication agents manage interactions with facility personnel, provide status updates, and coordinate maintenance activities with operational requirements.

External system integrations (604) enable seamless connectivity with existing enterprise systems including SCADA systems for real-time operational data exchange, ERP systems for financial and resource planning integration, computerized maintenance management systems for work order coordination, supply chain systems for parts procurement and vendor management, cloud services for scalable computing and data storage, loT platforms for device management and data aggregation, mobile applications for field personnel interfaces, and blockchain ledgers for asset provenance and service record maintenance.

Autonomous transaction processing capabilities, an instantiation of a Digital Autonomous Organisation (DAO), enable the system to execute maintenance-related transactions without human intervention while maintaining appropriate oversight and audit trails. Automated procurement processes generate purchase orders, negotiate pricing, and coordinate delivery schedules based on predictive maintenance requirements and budget constraints. Vendor negotiation algorithms utilize market data, historical pricing, and service quality metrics to optimize contract terms and pricing arrangements. Work order scheduling systems coordinate maintenance activities with operational requirements, personnel availability, and resource constraints. Payment processing systems automatically process invoices, validate service delivery, and maintain financial records. Compliance reporting systems generate required regulatory reports, safety documentation, and audit trails. Performance tracking systems continuously monitor system effectiveness, vendor performance, and cost optimization achievements.

The ecosystem architecture (606) delivers quantifiable benefits including significant reduction in unplanned downtime through proactive failure prevention, substantial cost savings through optimized maintenance scheduling and resource allocation, improved equipment lifespan through condition-based maintenance strategies, and near-complete automation of routine maintenance transaction processing.

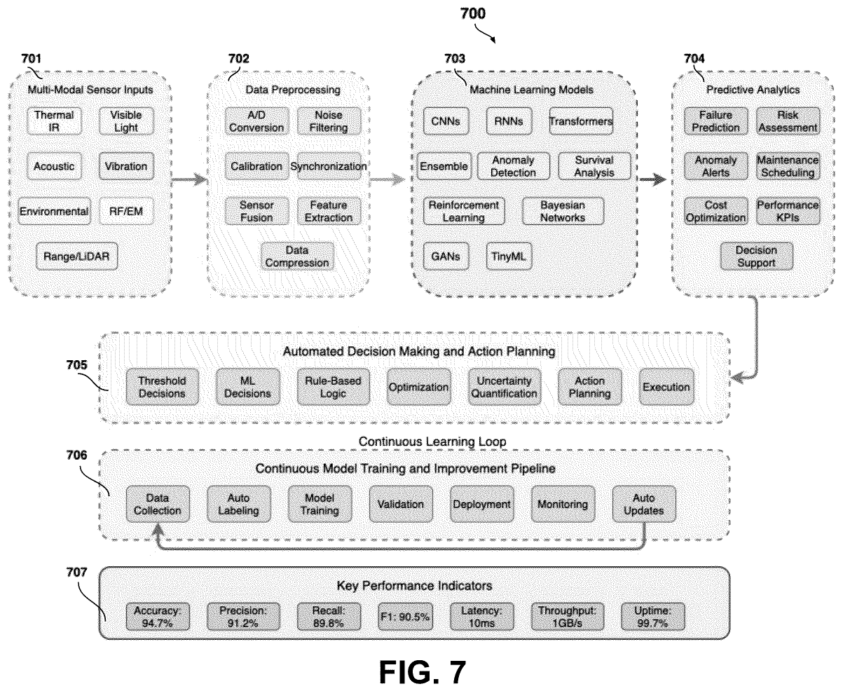

Referring to FIG. 7, the sensor data flow and machine learning pipeline (700) illustrates the comprehensive technical architecture that enables intelligent processing of multi-modal sensor data to generate actionable maintenance insights and autonomous decision-making capabilities. The pipeline demonstrates how raw sensor measurements transform through multiple processing stages into high-level business intelligence and automated action execution.

Multi-modal sensor inputs (701) provide the foundational data streams that feed the entire processing pipeline. Thermal infrared sensors operating in the 8-14 micrometer wavelength range capture thermal signatures of electrical equipment, mechanical components, and environmental conditions. These sensors detect temperature variations, hot spots, thermal gradients, and thermal signature changes that indicate equipment degradation, connection resistance increases, or operational anomalies. Visible light sensors operating across the 400-700 nanometer spectrum provide visual documentation, equipment identification capabilities, and change detection through image analysis techniques.

Acoustic sensors spanning frequencies from 20 Hz to 100 kHz detect equipment-generated sounds including mechanical vibrations, electrical arcing, partial discharge events, and other acoustic signatures associated with equipment operation and failure modes. Vibration sensors measuring frequencies from 0.1 Hz to 10 KHz capture mechanical vibration signatures that indicate bearing wear, shaft misalignment, unbalanced loads, and other mechanical condition indicators.

Environmental sensors monitor temperature, humidity, and pressure conditions that affect equipment performance and sensor measurement accuracy. Radio frequency and electromagnetic sensors detect electromagnetic emissions, power quality issues, and interference sources that may indicate equipment malfunctions or environmental conditions affecting operations. Range and LiDAR sensors provide distance measurements, spatial mapping, and change detection capabilities that enable monitoring of physical equipment configurations and detect unauthorized access or equipment modifications.

Data preprocessing (702) and fusion algorithms transform raw sensor measurements into calibrated, synchronized, and formatted data streams suitable for machine learning analysis. Analog-to-digital conversion systems digitize sensor outputs with appropriate sampling rates, resolution, and dynamic range for each sensor modality. Noise filtering and signal conditioning algorithms remove measurement artifacts, electromagnetic interference, and environmental noise while preserving relevant signal characteristics.

Sensor calibration and normalization algorithms ensure measurement accuracy and consistency across multiple sensors and environmental conditions. Calibration procedures account for sensor drift, temperature effects, aging characteristics, and environmental influences that affect measurement accuracy. Temporal synchronization and alignment algorithms ensure precise timing relationships between sensor measurements from different modalities, enabling accurate correlation analysis and multi-modal feature extraction.

Multi-modal sensor fusion algorithms combine information from multiple sensor types to generate comprehensive understanding of monitored equipment conditions. Kalman filtering techniques maintain optimal state estimates by combining sensor measurements with mathematical models of equipment behavior. Cross-modal correlation analysis identifies relationships between different sensor modalities that provide enhanced detection capabilities beyond individual sensor performance.

Feature extraction and engineering algorithms identify relevant patterns, trends, and characteristics within sensor data that correlate with equipment health, performance, and failure modes. Statistical features including mean values, standard deviations, trend slopes, and frequency domain characteristics provide baseline health indicators. Advanced feature extraction techniques identify complex patterns, non-linear relationships, and subtle changes that indicate developing problems before they manifest as obvious failures.

Data compression and storage optimization algorithms reduce data volume while preserving essential information content. Compression techniques utilize statistical redundancy, temporal correlations, and frequency domain characteristics to achieve significant data reduction without loss of diagnostic information. Intelligent data archiving strategies retain critical information while managing storage costs and access performance.

The machine learning model architecture (703) implements multiple specialized algorithms optimized for different aspects of equipment monitoring and failure prediction. Convolutional neural networks process thermal imagery and visual data to identify equipment types, detect anomalies, and track changes over time. Recurrent neural networks and transformer models analyze time-series data to identify temporal patterns, trends, and cyclical behaviors associated with equipment operation and degradation.

Ensemble methods including random forests and gradient boosting combine multiple individual models to improve prediction accuracy and robustness. Anomaly detection algorithms including isolation forests and one-class support vector machines identify unusual patterns and outlier conditions that may indicate developing problems. Survival analysis techniques including Cox regression models predict time-to-failure distributions and provide confidence intervals for maintenance planning.

Reinforcement learning algorithms optimize maintenance strategies through interaction with operational environments and feedback from maintenance outcomes. Bayesian networks provide uncertainty quantification and probabilistic reasoning capabilities that enable risk-based decision making under uncertain conditions. Generative adversarial networks create synthetic data for model training, system testing, and customer demonstrations.

TinyML implementations enable edge processing capabilities at the sensor level, reducing communication requirements and enabling real-time response to critical conditions. Edge processing capabilities include immediate anomaly detection, threshold monitoring, and local decision-making functions that operate independently of network connectivity.

Predictive analytics (704) and insights generation transforms machine learning model outputs into actionable business intelligence. Failure prediction algorithms generate probabilistic forecasts of equipment failures with associated confidence intervals and recommended intervention timelines. Risk assessment algorithms quantify potential consequences of equipment failures including safety risks, operational impacts, and financial costs.

Anomaly detection algorithms continuously monitor equipment conditions and generate alerts when unusual patterns or threshold violations occur. Maintenance scheduling optimization algorithms balance competing objectives including equipment reliability, operational requirements, resource availability, and cost constraints to recommend optimal maintenance timing and resource allocation.

Cost optimization analysis evaluates alternative maintenance strategies and resource allocation decisions to minimize total cost of ownership while maintaining required reliability levels. Performance metrics and key performance indicators provide quantitative measures of system effectiveness, equipment health, and maintenance strategy performance.

Automated decision making and action planning systems (705) transform predictive analytics into specific maintenance actions and resource allocation decisions. Threshold-based decisions provide immediate responses to critical conditions requiring urgent attention. Machine learning-driven decisions utilize predictive models to optimize maintenance timing, resource allocation, and strategy selection based on multiple competing objectives.

Rule-based logic systems implement expert knowledge and regulatory requirements to ensure maintenance decisions comply with safety regulations, operational procedures, and industry best practices. Multi-objective optimization algorithms balance competing objectives including cost, reliability, safety, and operational requirements to identify optimal maintenance strategies.

Uncertainty quantification techniques provide confidence intervals and risk assessments that enable informed decision-making under uncertain conditions. Action plan generation systems create detailed work plans including required resources, personnel assignments, scheduling constraints, and performance criteria.

The continuous model training and improvement pipeline (706) ensures maintained accuracy and adaptation to changing operational conditions. Historical data collection systems maintain comprehensive databases of sensor measurements, maintenance actions, and operational outcomes that enable continuous model refinement. Automated data labeling systems reduce manual annotation requirements while maintaining training data quality.

Distributed model training utilizes cloud computing resources to train complex models on large datasets while maintaining data security and privacy requirements. Cross-validation and testing procedures ensure model reliability and generalization performance. Model deployment systems manage the process of updating production models while maintaining system availability and performance.

Performance monitoring systems continuously track model accuracy, prediction quality, and business impact metrics. Automated model update systems identify when model retraining is required and execute update procedures with minimal system disruption.

Key performance indicators (707) demonstrate quantifiable system capabilities; for (a very concrete) example, per FIG. 7, it may be the case that prediction accuracy exceeds 94%, precision and recall rates are above 90%, F1-scores indicate balanced performance across different failure modes, response latency is below 10 milliseconds for critical alerts, data throughput capabilities exceed 1 gigabyte per second, and system uptime reliability is exceeding 99.7% ensuring continuous monitoring capability. These are fictitious, but illustrate the types of output and monitoring that are desired through the level of automation described here.

The sensor primitive architecture of the present invention provides flexibility through modular design principles that enable customization for diverse industrial monitoring applications. Each sensor primitive may incorporate a different sensor element type depending on the specific monitoring requirements of the target environment. Thermal sensing applications may utilize thermal focal plane arrays optimized for long-wave infrared detection, while visible spectrum monitoring may employ non-thermal focal plane arrays configured for standard optical wavelengths. Acoustic monitoring capabilities may be implemented through acoustic sensor elements, RF or (electric/magnetic) elements may enable field-sensing applications (current, voltage, noise) while environmental awareness may be achieved through pressure, temperature, and humidity sensors integrated within individual primitives.

The digitization architecture within each sensor primitive may be configured using various analog-to-digital conversion approaches, including dedicated analog-to-digital converters with variable precision, comparator-based digitization for threshold detection applications, or analog memory elements for continuous signal capture. This flexibility allows optimization of data conversion based on the temporal characteristics and precision requirements of different sensor modalities, including neuromorphic ones that sometimes map readily into neural networks and structures. High-frequency acoustic signals may benefit from high-speed comparator-based digitization, while thermal monitoring may utilize precision analog-to-digital converters with extended integration times.

Machine learning capabilities integrated within each sensor primitive may be implemented through TinyML architectures optimized for low-power edge computing, small CPU implementations for local processing, GPU-based acceleration for complex algorithms, or analog memory neural networks for ultra-low power operation. The selection of machine learning implementation depends on the computational complexity required for local data processing, power consumption constraints, and the need for real-time decision-making at the sensor level. Advanced predictive analytics may require GPU acceleration, while simple threshold detection and anomaly identification may be effectively handled by TinyML implementations. Sensor composites, by virtue of computational capacities included, e.g., in an MCU or GPU, will likewise have utility for compact ML workloads such as TinyML.

Power management within sensor primitives and composites accommodates diverse operational environments through flexible power conditioning approaches. Capacitor-diode networks provide basic power regulation and energy storage, while field-effect transistor networks enable active power management and load switching. Electrostatic discharge protection is integrated through dedicated ESD pads, while DC-DC conversion circuits ensure stable operation across varying input voltages. Active filter networks provide noise reduction and signal conditioning, ensuring reliable operation in electrically noisy industrial environments.

Communication and data interface capabilities support both local and distributed operation modes through multiple interface options. Memory interfaces may utilize DRAM-like architectures for high-speed data access, while serial communication may be implemented through SPI or 12C protocols for standardized device integration. Photonic light interfaces enable high-speed optical communication between sensor primitives, while Near Field Communication and Bluetooth provide wireless connectivity for configuration and data retrieval. Wi-Fi capability extends communication range for cloud connectivity and remote monitoring applications.

Local data storage within sensor primitives and/or composites may be implemented using various memory technologies optimized for different operational requirements. DRAM provides high-speed temporary storage for real-time processing applications, while SRAM offers low-power persistent storage for configuration data and intermediate results. Flash memory enables non-volatile storage of calibration parameters and historical data, while analog memory implementations provide unique capabilities for neuromorphic computing applications that may enhance pattern recognition and anomaly detection capabilities.

The physical interface components of sensor primitives and/or composites are specifically designed to optimize sensor performance while accommodating the mechanical and environmental constraints of industrial installations. Thermal sensing applications require specialized optical interfaces optimized for infrared wavelengths, typically implemented using germanium or other infrared-transparent materials that provide appropriate transmission characteristics while maintaining mechanical durability. The lens design for thermal sensors must account for the thermal expansion properties of both the lens material and the mounting structure to maintain optical alignment across the operational temperature range.

Visible spectrum sensing applications utilize glass-based optical systems designed for broadband transmission across the visible spectrum while providing appropriate focusing characteristics for the specific focal plane array configuration. Anti-reflective coatings may be applied to minimize optical losses and reduce unwanted reflections that could impact image quality. The mechanical mounting of visible light lenses must accommodate potential vibration and shock loads while maintaining precise optical alignment.

Acoustic sensing applications require specialized transducer interfaces that efficiently couple acoustic energy from the monitored environment to the sensing element. Piezoelectric transducers provide direct conversion of acoustic pressure variations into electrical signals, while electromagnetic transducers may be preferred for specific frequency ranges or sensitivity requirements. The acoustic coupling interface must be designed to minimize resonances and provide flat frequency response across the intended monitoring bandwidth when possible (a speaker cone can be considered as an impedance matching and beam shaping device).

Radiofrequency sensing and communication applications utilize antenna interfaces specifically designed for the intended frequency bands and radiation patterns. Patch antenna configurations provide directional sensitivity appropriate for spatially-resolved monitoring applications, while omni-directional antennas may be preferred for general communication functions. The antenna design must account for the proximity of other metallic components within the sensor primitive and/or composites and the dome structure to maintain appropriate radiation characteristics. In some embodiments, the sensor composite may comprise a planar element in place of a dome structure.

Dipoles or coils may find use as impedance matching devices for electric and magnetic fields, respectively such that voltages and currents could be located and measured using one or more such sensing apertures. Hall effect and electro optical/photonic devices may also find use for magnetic and electric field sensing, respectively, such that a plurality of devices is enabled to discriminate physical observables spatially.

Range finding and distance measurement applications may utilize LiDAR optical interfaces that combine laser transmission and optical reception capabilities within a single sensor primitive and/or composite. The optical design must provide appropriate beam divergence for the intended measurement range while maintaining sufficient optical isolation between transmitted and received signals to prevent interference. Time-of-flight measurement accuracy depends critically on the optical interface design and the associated signal processing algorithms.

The physical mounting and environmental protection of sensor composite interfaces must accommodate the diverse operational environments encountered in industrial monitoring applications. Sealed enclosures protect sensitive optical and electronic components from moisture, dust, and chemical contamination while providing appropriate thermal management. Vibration isolation may be required in high-vibration environments, while shock mounting protects against impact loads. The selection of materials and protective coatings must consider the specific chemical environment and potential exposure to corrosive substances or extreme temperatures.

The sensor primitive/composite architecture described above provides the foundation for the advanced mobile device integration and AI-driven sales automation capabilities that distinguish the present invention from conventional monitoring systems. When combined with mobile device sensors during site assessment and system configuration, the modular sensor primitive/composite design enables rapid prototyping and validation of sensor placement strategies. Mobile devices can capture environmental conditions and equipment configurations, while the sensor primitive/composite architecture allows real-time simulation of proposed monitoring configurations using synthetic data generation techniques.

The machine learning capabilities integrated within individual sensor primitives and/or composites provide the computational foundation for the distributed intelligence architecture that enables autonomous maintenance coordination and predictive analytics. Local processing within sensor primitives reduces communication bandwidth requirements while enabling real-time decision-making, supporting the autonomous transaction processing and vendor coordination capabilities that transform traditional reactive maintenance into proactive, AI-driven maintenance ecosystems.

The flexible communication interfaces supported by sensor primitives/composites enable seamless integration with mobile devices during site assessment, configuration, and demonstration phases. Wireless connectivity options allow mobile devices to communicate directly with deployed sensor primitives/composite for configuration validation and performance verification, while the modular architecture supports rapid reconfiguration based on mobile device analysis of site conditions and monitoring requirements.

In some embodiments, the sensor primitive (SP) may have the capability to sense electric and/or magnetic fields, e.g., using electric field sensitive integrated circuits (ICs) and/or Hall effect ICs, such that a distribution, e.g., linear array of SPs spanning a distribution of switchgear or other electrical apparatus, can be used to produce highly accurate estimates of electric and magnetic fields, the corresponding voltages and currents being carried, so as to provide meter grade measurements of electrical phenomena in support of the other sensory modalities, if any.

In some embodiments of the system, the computer-readable instructions executed at multiple locations, e.g., from SP to cloud, may further comprise generating, based on the single operational health assessment of the environment, a proposed action plan for improving health of the environment. In some embodiments, the proposed action plan may comprise a timeline, concerns of improving the health of the environment, a breakdown of issues per object, costs of replacement or repair, existing commitments, resources, domains of coordinated action, conditions of satisfaction, and options for adjusting the proposed action plan. In some embodiments, the plurality of sensors (401, 402, 140, 141, 142) may be further configured to compress the plurality of data streams before transmitting to subsequent computing systems (1080, 1030, 201). In some embodiments, the computer-readable instructions may further comprise mapping the plurality of data streams onto an industrial protocol register space. In some embodiments, for each sensor composite (400) of the one or more sensor composites, the plurality of sensors (401, 402, 140, 141) may be operatively coupled to each other in a daisy chain configuration. In some embodiments, for each sensor composite (400) of the one or more sensor composites, the plurality of sensors (401,402) may be communicatively coupled to the computing system (1030, 201) by a wired connection, a wireless connection, a network connection, or a combination thereof. In some embodiments, at least one of the plurality of data streams may comprise a heat distribution map indicative of wear and tear of the environment.

In general, the present invention relates to the automation of industrial thermography and electronic sensing of related physical observables that enable increased fidelity for interpreting the physical state of observed objects and contexts. In that regard, the following detailed description is merely exemplary in nature and is not intended to limit the inventions or the application and uses of the inventions described herein. Furthermore, there is no intention to be bound by any theory presented in the preceding background or the following detailed description. In the interest of brevity, conventional techniques, and components related to thermal imaging, image processing, computer processors, and calibration methods may not be described in detail herein as such topics are well known by those of ordinary skill in the art.

In accordance with one embodiment, in order to avoid unnecessary human risk resulting from measurement and/or unwanted intrusion, e.g., by living organisms such as animals and humans, the present invention enables the automation of thermographic measurement and intrusion detection such that a single system mitigates risk of harm to equipment and humans in an enterprise. Toward that end, embodiments of the present invention relate to an autonomous industrial security and safety system including one or more imaging devices with integral computing and data storage capacities configured in a network to which additional computers and storage devices may be connected, and to which a user may connect in order to access raw and processed data, and from which a user may receive automated communications concerning the current and likely future state of the physical assets being monitored. In accordance with one embodiment, the imaging device(s) comprises a modular multispectral imaging system for which a multiplicity of image sensor modules are used to measure and assess physical temperature across one or more distinct regions of interest throughout an industrial asset of interest, e.g., a sequence of switchgear cabinets each containing equipment and points of connection that are to be monitored.

The system acoustic sensors (209, 400) includes acoustic sensing for multiple purposes including: a) acoustic sensing and detection of equipment behaviors, e.g., electrical arcing that emits acoustic energy inside and beyond the human audio range; b) acoustic communication, e.g., using ultrasonic frequencies, such that information could be shared between sensor devices and aggregations 200, 140, 141, 142 or Gateway 110 components when acoustic paths are available for transmission and reception; c) acoustic ranging, or sonar, such that objects in proximity to the sensor devices and aggregations 200, 140, 141, 142 can be assessed for distance from the sensor devices and aggregations and this distance can inform the imaging elements, e.g., 202, 203, 400, 1000, for use in object analysis, e.g., localization, registration, identification, and categorization; and d) for synthesizing an aperture using acoustic amplitude and phase information available within a system or spanning a plurality of acoustic sensor primitives and/or composites arrayed with respect to the sensed region.

Accordingly, the acoustic sources e.g., 208, support communication, e.g., through coded modulation, and ranging, e.g., through continuous wave or pulsed modulation-two common modulation schemes for such devices. In more detail, referring to the invention of FIG. 1A, the various elements of the multi sensor smart camera 200 or sensor composite (400) can be constructed as a single integrated circuit or as a multi-chip module in order to minimize its size, with attention given to the optics required for the distinct wavebands of the Thermal e.g., 203 and Non-Thermal e.g., 202 imaging devices, as these typically require different materials for optimal lenses, with a few notable exceptions including reflective optics.

Referring again to the invention of FIG. 1A, the organization of components can be generalized such that the multi sensor smart camera or sensor composite 200, 400 can be constructed with modular integrated circuit devices that are compatible with one another in both monolithic and multi-chip configurations. It is understood that, for some configurations, economics will encourage one realization over another concerning monolithic versus multi-chip realizations of a Sensing Primitive. However, for many situations, a monolithic form will be both performant and economic.

Referring again to the invention of FIG. 2 it is of particular interest for the area of application of the invention that small spaces be readily monitored and assessed with the Sensing Module; these spaces have difficult geometries to accommodate with traditional imaging devices, e.g., switchgear cabinets and related enclosed equipment, such that there is significant advantage in using many small image devices to image a large area, instead of a large (and expensive) image device with distortive, large and costly optics that are customized to a particular geometry. Accordingly, the SP enables the use of many small focal plane arrays, for instance, to cover a large area or an area that is not shaped such that a single focal plane and optic could image it effectively and affordably.

Referring to FIG. 3, the invention, making using of SP elements, can sense a large field of view through what amounts to a biomimetic construction-making a “bug-eye” that has a multiplicity of apertures distributed across the half-plane, for the example shown—there are no limits to the possible configurations. Thus, instead of, for instance, using a distortion wide angle thermal and color lens paired with a 100×200 thermal infrared array and combining it with a 1000×2000 color array for thermal and color (visible light) imaging of a shared field of view that has useful data for only ⅓ of the imaged area (distortions and mappings are wasteful of pixels), three or four 30×60 thermal arrays ( 1/10 the area) and 100×200 color arrays ( 1/100 the area) could be deployed with small low distortion optics to image the region of interest with useful data in 90% of the imaged area. In the case of 4× SPs, this would yield an efficiency improvement of 10× or more which translates into reduced cost.

The invention further contemplates that, in constructing a Sensing Module based on multi-SP arrangements, the SPs can be arranged as distinct ICs or as a monolithic device. Different geometries encourage different strategies for arranging components. However, the SP as a design element can be accommodated this way using existing fabrication and packaging technologies, as would be known to one skilled in the art.

This multi-SP approach to producing the Sensing Module enables a modular design strategy that accords with trends in IC manufacture-namely, the use of multi-project wafers to create relatively small batches of ICs for shared cost. This strategy opens the possibility of a highly customized unique-per-customer IC configuration that makes it possible to address the segmentation of the markets optimally for both cost and performance. Alternately, the multi-SP configuration can be used to produce custom configurations for each asset class in the many industrial segments.

In some embodiments, the SP of the present invention may enable multi-FPA IC that breaks the problem into multiple bug-eye problems. Optics can be carried by package and can be polystyrene/acrylic, germanium/bk7, or a combination thereof. The SP may further implement overlapping multispectral tiny focal plane arrays with TinyML™ functionality and a scalable design at an integrated circuit level for dicing or integrating. The SP may be scalable at an optical level. In some embodiments, the SP of the present invention may be capable of accounting for resolution, field of view, overlap, distortion, point spread function (PSF)/modulation transfer function (MTF), joint optimums, light detection and ranging (LIDAR), short-wave infrared ranging (SWIR), and visible/near-infrared detection.

In accordance with various embodiments of the invention, when the probability of object, e.g., equipment or system, failure or unacceptable operation is detected to be above a predetermined threshold (the “Event”) using the available means and methods of interpreting data, a maintenance or replacement strategy can be computed and communicated to equipment owners or operators, such that the owners or operators are able to execute the strategy and prevent loss of equipment availability or acceptable equipment performance. The computed strategy, being, in essence, a commercial offer comprising a data structure, can contain one or more of the following fundamental elements of a commercial Offer: a timeline or time horizon for offer acceptance, concerns, breakdowns, value criteria, existing commitments, references or links to the owner, and domains of coordinated action.

In some embodiments, the strategy may comprise one or more deadlines for one or more actions to address the Event, e.g., a replacement or maintenance schedule. In some embodiments, the strategy may further comprise estimated Event effects upon operational performance in terms of profits, revenues, and production costs, e.g., energy consumption, safety, reliability, etc. In some embodiments, the strategy may further comprise estimates of collateral breakdowns or related equipment affected by the Event, e.g., downstream or upstream equipment having some known dependence upon or relationship to Event equipment. In some embodiments, the strategy may further comprise estimated costs of replacement or repair in relation to accepting the Offer. In some embodiments, the strategy may further comprise alternative actions for leveraging compatible equipment already owned or available from a supplier, and/or references to existing and/or new Supplier points of contact. In some embodiments, the strategy may further comprise manuals, documents, or procedures predetermined or for the equipment Event, or computed based on algorithmic assessments derived from Event data, or combinations thereof. In some embodiments, the strategy may further comprise lists of associated actions that may be taken to create value for the Owner and Supplier, for instance, and that the parties may act jointly in.

The strategy may further comprise a plan of action based on one or more suppliers that describe one or more of the components, actions, staff, timeline, and prices associated with strategies to address the Event satisfactorily. The strategy may further comprise a list of suppliers and possible contracts having diverse structures and organizations, e.g., variable service levels or component configurations or personnel, or warranties, etc. The strategy may further comprise an incremental offer to produce conditions of satisfaction using an auction, e.g., automated in part or in whole, amongst the Supplier options or within the space of possibilities created with the diversity of possible outcomes, including new offers solicited from the broader marketplace, e.g., an approved vendor list or an online industrial marketplace. The strategy may further comprise the requirements that the Owner will be responsible for fulfilling upon acceptance of one of the offers. This may include references to the Owner or Supplier personnel who are relevant to Event management and may coordinate actions to produce a satisfactory outcome for the Owner.

In accordance with various embodiments of the invention, an Offer made by a Supplier based on an Event can be made using cryptocurrency, whether in a publicly traded form, e.g., Bitcoin™, Ethereum™, or in a private form constructed for the purpose of conducting business within a community or organization, such organization comprising at least two parties to a transaction or series of transactions. For example, such a structure could be formed using a digital autonomous organization (DAO) for the purpose of supporting ongoing transactions between parties, such parties comprising a marketplace.

In accordance with various embodiments of the invention objects, e.g., Equipment, once having been detected, identified, and categorized (either manually or automatically or combinations thereof), can be associated with a unique identity using cryptographic data structures such that a blockchain ledger can be used to track the asset over time, including through its service life and repair cycles. This permits the addition of new parts and components, e.g., as repairs or service events are executed, by way of additional cryptographic identifiers associated with the parts added, replaced, or serviced.

In accordance with various embodiments of the invention, the sensor data, e.g., images or other physical measurement data, can be compressed to minimize the cost of transmitting and storing the data over time, and such compressed data may be stored in registers associated with the industrial communication protocol in use at the Owner site, e.g., Modbus™. For example, the address space of the Modbus™ protocol permits storing groupings of 32,000 16-bit data values, or 16 bits of byte data address space. Using this register or address space for compression products would permit the storage of compressed images in whole or in part. Further, the invention contemplates the calculation of an optimum register mapping of raw or compressed data products from the sensors such that all sensor data can be captured by industrial automation processes having data historians or human-machine interfaces.

For example, an algorithm to produce a mapping of sensor data onto an industrial protocol register space comprises entering Owner automation equipment industrial protocol address range, timing and frequency of device queries, and required sample timing for observation of physical observables of concern, e.g., the thermographic image capture frequency. The algorithm may further comprise using this data to compute an Owner available data density, e.g., data elements or bytes per unit time. The algorithm may further comprise calculating, from the configuration of sensor data elements, the number of single-value and multiple-value data records, their sizes. The algorithm may further comprise calculating the data density (data elements per unit time) for each sensor data record and creating a record of all such data records. The algorithm may further comprise prioritizing the sensor data records according to a predetermined, e.g., Owner informed, priority schedule and allocate the data density to the Owner available data density, proceeding from highest priority to lowest. For data elements that are lower in priority and that have data gaps resulting from the remainder Owner data density, the algorithm may further comprise computing the interpolation required to fill gaps and report this value as part of a setup report communicated to installers that are working with the invention in an industrial context.

In accordance with various embodiments of the invention, data compression for sensor data, whether single or multi-dimensional (e.g., 2D imagery), can be accomplished by various means, including but not limited to constructing and recording a background data record that is a statistically “normal” representation, e.g., a running average, and recording updates to this normal record using predetermined regions of interest (ROI) that are either temporal or spatial or both temporal and spatial, such updates being sent when the ROI data vary from the normal data by a predetermined amount, such amount articulated in either absolute or relative/statistical terms, e.g., when the change is greater than one standard deviation of the sample variations of the data.

Data compression for sensor data may further comprise constructing and recording a background data record that is a statistically “normal” representation, e.g., a running average, and recording updates to this normal record using run-length encoding, where the encoding can use a lookup table (LUT) to support varying levels of compression. Data compression for sensor data may further comprise using the background data record and machine learning to optimize the LUT for characteristics peculiar to the Owner and or device context, including the optimization as a function for specific objects, and classes of objects, including by manufacturer. Data compression for sensor data may further comprise using standard compression libraries, e.g., zip or JPEG, to produce single or multi-dimensional compressed data. In accordance with various embodiments of the invention, the available computing resources can be used to support common network protocols, e.g., TCP/IP, over the industrial bus, e.g., CANBUS, ModbusTCP, etc., so that the installed based on industrial bus resources of an Owner become accessible or extendable to additional networks when needed. In accordance with various embodiments of the invention, the available computing resources, and historical data, to the extent available, can be used to compute update rates for the transmission of data that vary according to a risk calculation, e.g., the probability of equipment failure.

In accordance with various embodiments of the invention, in order to avoid single points of failure for operation and given the daisy-chain configuration of the Multiple Sensor Modules, wiring can be installed so as to provide redundant paths for data in the event of a breakdown, e.g., a cable is cut or damaged. This can be accomplished by applying principles of graph theory to wiring configurations such that a spanning tree configuration is produced that can handle one or more breakages of connectivity. This concept can be expanded for communications by using multiple modes of communication, e.g., a combination of CANBUS, WiFi, Acoustic modes, selected at specific locations of the networked Modules to optimize security and safety, and robustness with respect to network failure, which could produce graph structures that produce communication spanning tree robustness (wireless connections would not provide such for power supply connectivity, which would need to be addressed separately, albeit with significant reductions in wires required).

In accordance with the invention, communication can be supported by wired and wireless modes, such that multiple orthogonal (orthogonal in the signal theoretic sense) channel communication can be accomplished that is more secure and robust than a single mode by itself. For instance, acoustic modes could be used to cross short distances of open space and radio frequency wireless modes could be confined to spaces where the cabinetry produces a Faraday cage for communication within the cabinet. Alternately, the multiple modes could be used to provide distinct elements of data so as to enhance security—a cryptographic key could be passed over one mode and the encrypted data could be sent over a separate mode such that listeners would have the costliest encryption problem to solve in order to gain entry to a network.

In accordance with various embodiments of the invention, the observation of thermographic imagery over time will produce data that can be used with machine learning algorithms to associate a particular evolution of heat distribution for an object that is indicative of its state of “wear and tear” such that the emergence of a particular class or character or shape of heat distribution can be used to assess the need for maintenance or the likely onset of a breakdown. This distribution thus becomes a spatio-temporal threshold to use for ongoing detection and decision-making.

In summary, an automated thermal imaging system in accordance with one embodiment includes a thermal infrared camera module configured to produce thermal images of objects at a site within its field of view; a power source; and a computer processor communicatively coupled to the thermal infrared camera module, the network interface, and the power source. The computer processor is configured to detect and classify a set of objects of interest within image data from the system, produce state data characterizing the temperatures of the objects of interest, and transmit the state data to a remote server via the network interface.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices.

Mobile Device Integration System: In accordance with various embodiments, the present invention features a mobile device integration system comprising a portable computing device having imaging capabilities, three-dimensional sensing capabilities, or both, configured to capture environmental data from an industrial site. The mobile device may comprise a smartphone, tablet, handheld scanner, or other portable computing device having one or more cameras, depth sensors, LiDAR sensors, or combinations thereof. The mobile device may be communicatively coupled to a remote computing system configured to process the captured environmental data and generate automated system configuration recommendations.

The mobile device integration system may be configured to automatically recognize and classify industrial equipment within the captured environmental data using computer vision algorithms, machine learning models, or both. Equipment recognition may include identification of switchgear types, electrical panel configurations, circuit breaker arrangements, transformer installations, or other industrial equipment. The system may access a database of equipment specifications, failure statistics, thermal characteristics, and maintenance requirements to inform automated analysis and recommendations.

Automated Site Analysis and Configuration: In accordance with various embodiments, the present invention features methods for automated site analysis comprising capturing three-dimensional spatial data of an industrial environment using a mobile device, processing the spatial data to identify equipment locations and configurations, and automatically generating optimal sensor placement recommendations. The sensor placement optimization may consider line-of-sight requirements, thermal monitoring coverage areas, accessibility for maintenance, power supply requirements, communication network topology, or combinations thereof.

The automated configuration system may generate multiple sensor deployment scenarios with corresponding cost analyses, coverage assessments, and installation complexity ratings. Each scenario may include specific sensor types, quantities, mounting locations, field-of-view specifications, and integration requirements with existing industrial control systems. The system may optimize sensor placement to maximize coverage of critical thermal monitoring points while minimizing total system cost, installation complexity, and ongoing maintenance requirements.

Synthetic Data Generation and Customer Demonstration: In accordance with various embodiments, the present invention features synthetic data generation capabilities configured to create simulated sensor data streams based on identified equipment characteristics, operational parameters, and historical failure patterns. The synthetic data may comprise thermal imagery, temperature readings, acoustic signatures, vibration patterns, or other sensor modalities corresponding to normal operational states, degraded equipment conditions, or failure scenarios.

The synthetic data generation system may access databases of equipment thermal behavior models, failure progression patterns, and environmental factors to create realistic simulated sensor outputs. The generated data may be used to demonstrate system capabilities to prospective customers, train machine learning models, validate system performance, or support sales and marketing activities. The system may generate interactive demonstrations allowing users to explore different equipment failure scenarios and observe corresponding system responses.

AI-Driven Sales Automation: In accordance with various embodiments, the present invention features an AI-driven sales automation system configured to automate aspects of customer engagement, system configuration, proposal generation, and transaction processing. The sales automation system may comprise natural language processing capabilities, customer relationship management integration, automated proposal generation, and dynamic pricing optimization based on site-specific risk assessments and configuration requirements.

The sales automation system may automatically generate technical proposals comprising system specifications, installation plans, cost analyses, return-on-investment calculations, and maintenance contract options. Proposal generation may be based on automated site analysis results, customer-specific requirements, equipment risk assessments, and market pricing data. The system may optimize proposals to maximize customer value while maintaining target profit margins and competitive positioning.

AI Embodiment in Industrial Maintenance Ecosystems: In accordance with various embodiments, the present invention enables AI embodiment in industrial maintenance operations through a distributed intelligence architecture comprising sensor networks, machine learning models, and automated decision-making systems. The AI embodiment concept refers to providing artificial intelligence systems with physical sensing capabilities and automated action mechanisms such that the AI can perceive, analyze, and respond to real-world industrial conditions with minimal human intervention. This embodiment transforms traditional reactive maintenance approaches into proactive, predictive, and autonomous maintenance ecosystems.

The AI embodiment system may comprise multiple interconnected intelligence layers: a sensor intelligence layer for real-time environmental perception, a predictive intelligence layer for failure forecasting and risk assessment, a business intelligence layer for economic optimization and decision-making, and a communication intelligence layer for stakeholder engagement and transaction processing. Each intelligence layer may utilize specialized machine learning models trained on domain-specific datasets comprising sensor readings, equipment specifications, failure histories, maintenance records, and economic parameters.

Machine Learning Workflow Architecture: The machine learning workflow architecture may comprise a multi-stage pipeline configured for continuous learning and adaptation. The first stage may comprise data preprocessing and feature extraction from multi-modal sensor streams, including thermal imagery processing, acoustic signature analysis, vibration pattern recognition, and environmental condition normalization. Feature extraction may utilize convolutional neural networks (CNNs) for image-based data, recurrent neural networks (RNNs) for time-series data, and transformer architectures for cross-modal feature fusion.

The second stage may comprise predictive model training using ensemble methods combining multiple machine learning approaches. Equipment failure prediction may utilize gradient boosting algorithms trained on historical failure data, maintenance records, and sensor reading progressions. Risk assessment models may employ Bayesian networks to quantify uncertainty and provide confidence intervals for failure predictions. Economic optimization models may utilize reinforcement learning algorithms to optimize maintenance scheduling, resource allocation, and cost-benefit analysis based on learned reward functions reflecting business objectives.

Large Language Model Integration and Training: The system may incorporate large language model (LLM) capabilities for natural language processing, customer communication, and technical documentation generation. LLM training may utilize domain-specific datasets comprising maintenance manuals, technical specifications, failure reports, customer communications, and industry regulations. The training process may employ transfer learning techniques, starting with pre-trained language models and fine-tuning on industrial maintenance domain data to achieve specialized performance in technical communication and documentation.

The LLM integration may enable automated generation of technical proposals, maintenance reports, customer communications, and regulatory compliance documentation. The system may utilize prompt engineering techniques to guide LLM outputs for specific use cases, including customer objection handling, technical explanation generation, and proposal customization based on customer-specific requirements. The LLM may be configured to access real-time sensor data and incorporate current equipment conditions into generated communications, enabling dynamic and contextually relevant customer interactions.

Economic Value and ROI Optimization Framework: The present invention provides quantifiable economic value through multiple optimization mechanisms. Primary value generation may include prevention of catastrophic equipment failures, with cost avoidance calculations based on failure probability models, downtime cost assessments, and replacement cost analyses. The system may automatically calculate return on investment (ROI) metrics by comparing monitoring system costs against projected failure costs, incorporating probability-weighted risk assessments and time-value-of-money calculations.

Secondary value generation may include operational efficiency improvements through optimized maintenance scheduling, reduced emergency maintenance events, and enhanced equipment lifespan through proactive care. The system may track and quantify these benefits through continuous monitoring of maintenance costs, equipment performance metrics, and operational availability measurements. Tertiary value generation may include improved regulatory compliance, reduced insurance costs, and enhanced safety performance, with quantification based on incident reduction rates and compliance audit results.

Distributed Intelligence and Autonomous Transaction Processing: The system may implement distributed intelligence architecture enabling autonomous transaction processing throughout the maintenance ecosystem. This may include automated vendor communications for parts procurement, dynamic pricing negotiations based on market conditions and urgency levels, and autonomous maintenance scheduling optimization considering equipment criticality, resource availability, and cost constraints. The distributed intelligence may utilize multi-agent systems where individual agents specialize in specific functions such as failure prediction, resource optimization, vendor management, and customer communication.

Autonomous transaction processing may incorporate blockchain-based verification systems for maintaining transparent and immutable records of maintenance activities, parts authenticity, and service provider credentials. Smart contract implementations may enable automated payment processing, service level agreement enforcement, and performance-based compensation structures. The system may maintain cryptographic audit trails enabling retrospective analysis of decision-making processes and outcomes for continuous system improvement and regulatory compliance.

Synthetic Data Generation Technical Implementation: Synthetic data generation may utilize generative adversarial networks (GANs) trained on multi-modal sensor datasets to create realistic simulated equipment behavior across various operational and failure states. The generator networks may be conditioned on equipment specifications, operational parameters, and environmental conditions to produce targeted synthetic data streams. Discriminator networks may ensure synthetic data quality and realism through adversarial training processes that refine generator outputs to match real-world sensor data distributions.

The synthetic data generation system may incorporate physics-based modeling approaches combined with machine learning techniques to ensure synthetic data adheres to thermodynamic principles, electrical behavior models, and mechanical system constraints. This hybrid approach may enable generation of synthetic data for equipment configurations and failure modes not present in historical datasets, supporting customer demonstrations and system validation for novel installations.

Multi-Modal Sensor Fusion Algorithms: The multi-modal sensor fusion system may utilize Kalman filtering techniques to combine thermal, visual, and acoustic sensor data streams with temporal consistency. The Extended Kalman Filter (EKF) or Unscented Kalman Filter (UKF) may be employed to handle non-linear sensor relationships and maintain state estimates across multiple sensor modalities. Sensor data may be synchronized using timestamp alignment algorithms that account for varying sensor sampling rates and communication latencies. Cross-modal correlation analysis may utilize canonical correlation analysis (CCA) or mutual information techniques to identify relationships between different sensor types monitoring the same physical phenomena.

Feature-level fusion may employ concatenation of extracted features from individual sensor modalities, followed by dimensionality reduction using Principal Component Analysis (PCA) or Linear Discriminant Analysis (LDA). Decision-level fusion may utilize weighted voting schemes or Dempster-Shafer evidence theory to combine classification results from individual sensor modalities. The fusion weights may be dynamically adjusted based on sensor reliability metrics, signal-to-noise ratios, and historical performance data for each sensor type under varying environmental conditions.

Computer Vision for Equipment Recognition: Equipment recognition may utilize deep convolutional neural network architectures including ResNet, EfficientNet, or Vision Transformer models for object detection and classification. Object detection may employ region-based CNN (R-CNN) variants including Faster R-CNN or YOLO (You Only Look Once) architectures for real-time equipment identification. Feature extraction may utilize pre-trained backbone networks followed by custom classification heads trained on domain-specific equipment datasets comprising switchgear, transformers, circuit breakers, and associated electrical infrastructure.

Three-dimensional object recognition may utilize point cloud processing techniques including PointNet or PointNet++ architectures for processing LiDAR data. Simultaneous Localization and Mapping (SLAM) algorithms may be employed to create consistent spatial maps of industrial environments while tracking mobile device pose. Bundle adjustment techniques may be used to refine 3D reconstructions by minimizing reprojection errors across multiple viewpoints. Mesh generation from point cloud data may utilize Poisson surface reconstruction or Delaunay triangulation methods.

Thermal Image Analysis and Anomaly Detection: Thermal image analysis may employ histogram-based techniques for temperature distribution analysis, including histogram equalization and adaptive histogram equalization for contrast enhancement. Gradient-based edge detection algorithms including Sobel, Canny, or Roberts operators may be used to identify thermal boundaries and hot spot regions. Morphological operations including erosion, dilation, opening, and closing may be applied for noise reduction and feature enhancement in thermal imagery.

Anomaly detection in thermal data may utilize statistical methods including Gaussian mixture models, isolation forests, or one-class Support Vector Machines (SVM) for identifying temperature patterns that deviate from normal operational signatures. Time-series anomaly detection may employ autoregressive integrated moving average (ARIMA) models, Long Short-Term Memory (LSTM) networks, or Transformer-based architectures for detecting temporal anomalies in thermal progression patterns. Change point detection algorithms including CUSUM (Cumulative Sum) or PELT (Pruned Exact Linear Time) may be used to identify abrupt changes in thermal behavior patterns.

Optimization Algorithms for Sensor Placement: Sensor placement optimization may be formulated as a coverage optimization problem solvable using integer linear programming (ILP) or mixed-integer programming (MIP) techniques. Objective functions may include maximizing coverage area, minimizing sensor count, or optimizing cost-effectiveness metrics subject to constraints including line-of-sight requirements, power availability, and communication connectivity. Metaheuristic optimization algorithms including genetic algorithms, particle swarm optimization, or simulated annealing may be employed for large-scale sensor placement problems where exact solutions are computationally intractable.

Multi-objective optimization techniques including Pareto optimization or weighted sum methods may be used to balance competing objectives such as coverage maximization, cost minimization, and installation complexity reduction. Visibility analysis may utilize ray-tracing algorithms or shadow mapping techniques to determine line-of-sight constraints between potential sensor locations and monitoring targets. Network topology optimization may employ graph theory algorithms including minimum spanning tree or shortest path algorithms to optimize communication network connectivity.

Predictive Modeling and Failure Forecasting: Failure prediction models may utilize survival analysis techniques including Cox proportional hazards models or Weibull regression to estimate time-to-failure distributions based on sensor data trends. Feature engineering for predictive models may include statistical moments, spectral analysis features, and trend analysis metrics extracted from multi-modal sensor time series. Ensemble methods including Random Forest, Gradient Boosting, or XGBoost may be employed to combine multiple predictive models and improve forecast accuracy.

Uncertainty quantification in predictive models may utilize Bayesian inference techniques including Markov Chain Monte Carlo (MCMC) sampling or variational inference methods. Confidence intervals for failure predictions may be computed using bootstrap resampling or Bayesian credible intervals. Model validation may employ cross-validation techniques including time-series cross-validation or walk-forward validation to assess predictive performance on historical data while maintaining temporal ordering.

### Example

The following is a non-limiting example of the present invention. It is to be understood that said example is not intended to limit the present invention in any way. Equivalents or substitutes are within the scope of the present invention.

Complete Sales-to-Service Automation Scenario: For example, given an automated thermography product line having modules that can be placed to produce spatially registered thermographic sensory data over time, the complete sales conversation and subsequent service delivery proceeds as follows. A sales representative approaches a manufacturing facility experiencing periodic electrical outages and presents market data indicating that facilities with similar electrical load profiles experience an average of 2.3 switchgear failures annually, resulting in $47,000 average downtime costs per incident. The sales representative requests permission to conduct a brief site assessment using a mobile device equipped with thermal imaging and three-dimensional sensing capabilities.

During the site visit, the sales representative captures comprehensive environmental data of the facility's electrical infrastructure using a smartphone or tablet device. The mobile device's integrated sensors collect thermal imagery, three-dimensional spatial mapping, and photographic documentation of switchgear configurations, electrical panels, and associated infrastructure. This captured data is transmitted to a cloud-based analysis system where machine learning algorithms automatically identify and classify equipment types, configurations, and potential monitoring points. The system recognizes specific equipment models, manufacturers, and installation configurations, cross-referencing this information against databases of equipment specifications, typical failure modes, and optimal monitoring strategies.

The automated analysis system generates multiple sensor deployment scenarios within minutes of data capture. For instance, the system may identify twelve critical thermal monitoring points across three electrical panels and recommend a configuration utilizing two dome-based multi-sensor devices positioned to provide comprehensive coverage. The system calculates that this configuration would monitor 94% of critical thermal points with less than 5% blind spots, compared to alternative configurations requiring four separate devices to achieve equivalent coverage. The analysis includes precise mounting locations, field-of-view specifications, power supply requirements, and integration pathways with the facility's existing building management system.

To demonstrate system capabilities, the analysis system generates synthetic thermal data streams based on the identified equipment characteristics and typical operational parameters. The synthetic data simulates normal operational thermal signatures, gradual degradation patterns, and acute failure scenarios specific to the equipment types present at the facility. The sales representative presents an interactive demonstration on a tablet device, showing the customer exactly how thermal anomalies would appear on their monitoring dashboard, what alert messages would be generated, and how maintenance recommendations would be automatically formulated. The customer can manipulate simulation parameters to observe system responses to different failure scenarios, seasonal temperature variations, and load condition changes.

The system automatically generates a comprehensive technical proposal including equipment specifications, installation procedures, system integration requirements, and detailed cost-benefit analysis. The proposal calculates a projected return on investment of 340% over three years based on failure prevention statistics, reduced maintenance costs, and improved operational efficiency. The proposal includes multiple service level options, from basic monitoring with human-reviewed alerts to fully automated maintenance scheduling with integrated vendor management. Dynamic pricing optimization ensures the proposal remains competitive while maintaining target profit margins based on real-time market conditions and customer-specific risk profiles.

Following customer acceptance and system installation, the deployed sensors begin continuous monitoring of the facility's electrical infrastructure. Within six months of operation, the system detects gradual thermal signature changes in a main distribution panel indicating developing connection resistance in a primary feed conductor. The machine learning models, trained on thousands of similar degradation patterns, predict a 73% probability of connection failure within 90 days if corrective action is not taken. The system automatically generates a maintenance alert including thermal imagery, trend analysis, specific repair recommendations, and estimated costs for both proactive repair and reactive failure scenarios.

The automated maintenance coordination system identifies qualified electrical contractors from a pre-approved vendor network, solicits competitive bids for the recommended repair work, and presents the facility manager with optimized maintenance scheduling options. The system coordinates with the facility's production schedule to minimize operational disruption, automatically negotiating with vendors for optimal timing and pricing. Upon completion of maintenance work, the system validates repair effectiveness through continued thermal monitoring, documenting improved thermal signatures and updating predictive models with successful intervention data.

This complete scenario demonstrates the integration of mobile device sensing, automated analysis, synthetic data generation, customer engagement, predictive maintenance, and autonomous service coordination. The system transforms a traditional reactive maintenance approach into a proactive, data-driven maintenance ecosystem that optimizes both technical performance and economic outcomes. The cumulative effect is a reduction in unexpected failures, optimization of maintenance costs, and improved operational reliability across the facility's electrical infrastructure.

In addition, those skilled in the art will appreciate that embodiments of the present disclosure may be practiced in conjunction with any number of systems and that the systems described herein are merely exemplary embodiments of the present disclosure. Further, the connecting lines shown in the various figures contained herein are intended to represent example functional relationships and/or physical couplings between the various elements. It should be noted that many alternative or additional functional relationships or physical connections may be present in an embodiment of the present disclosure.

As used herein, the terms “module” or “controller” refers to any hardware, software, firmware, an electronic control component, processing logic, and/or processor device, individually or in any combination, including without limitation: application integrated circuits (ASICs), field-programmable gate arrays (FPGAs), dedicated neural network devices (e.g., Google Tensor Processing Units), electronic circuits, processors (shared, dedicated, or group) configured to execute one or more software or firmware programs, a combinational logic circuit, and/or other suitable components that provide the described functionality.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

The computer system can include a desktop computer, a workstation computer, a laptop computer, a netbook computer, a tablet, a handheld computer (including a smartphone), a server, a supercomputer, a wearable computer (including a SmartWatch™), or the like and can include digital electronic circuitry, firmware, hardware, memory, a computer storage medium, a computer program, a processor (including a programmed processor), an imaging apparatus, wired/wireless communication components, or the like. The computing system may include a desktop computer with a screen, a tower, and components to connect the two. The tower can store digital images, numerical data, text data, or any other kind of data in binary form, hexadecimal form, octal form, or any other data format in the memory component. The data/images can also be stored in a server communicatively coupled to the computer system. The images can also be divided into a matrix of pixels, known as a bitmap that indicates a color for each pixel along the horizontal axis and the vertical axis. The pixels can include a digital value of one or more bits, defined by the bit depth. Each pixel may comprise three values, each value corresponding to a major color component (red, green, and blue). A size of each pixel in data can range from 8 bits to 24 bits. The network or a direct connection interconnects the imaging apparatus and the computer system.

The term “processor” encompasses all kinds of apparatus, devices, and machines for processing data, including by way of example a programmable microprocessor, a microcontroller comprising a microprocessor and a memory component, an embedded processor, a digital signal processor, a media processor, a computer, a system on a chip, or multiple ones, or combinations, of the foregoing. The apparatus can include special-purpose logic circuitry, e.g., an FPGA (field programmable gate array) or an ASIC (application-specific integrated circuit). Logic circuitry may comprise multiplexers, registers, arithmetic logic units (ALUs), computer memory, look-up tables, flip-flops (FF), wires, input blocks, output blocks, read-only memory, randomly accessible memory, electronically-erasable programmable read-only memory, flash memory, discrete gate or transistor logic, discrete hardware components, or any combination thereof. The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The processor may include one or more processors of any type, such as central processing units (CPUs), graphics processing units (GPUs), special-purpose signal or image processors, field-programmable gate arrays (FPGAs), tensor processing units (TPUs), and so forth.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, a data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, drives, or other storage devices). The operations described in this specification can be implemented as operations performed by a data processing apparatus on data stored on one or more computer-readable storage devices or received from other sources.

Program code embodied on a computer readable medium may be transmitted using any appropriate medium, including but not limited to wireless, wireline, optical fiber cable, R.F, Bluetooth, storage media, computer buses, etc., or any suitable combination of the foregoing. Computer program code for carrying out operations for aspects of the present disclosure may be written in any combination of one or more programming languages, including an object oriented programming language such as Java, Smalltalk, C#, Ruby, or the like, conventional procedural programming languages, such as Pascal, FORTRAN, BASIC, or similar programming languages, programming languages that have both object-oriented and procedural aspects, such as the “C” programming language, C++, Python, or the like, conventional functional programming languages such as Scheme, Common Lisp, Elixir, or the like, conventional scripting programming languages such as PHP, Perl, Javascript, or the like, or conventional logic programming languages such as PROLOG, ASAP, Datalog, or the like.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. To provide for interaction with a user, embodiments of the subject matter described in this specification can be implemented on a computer having a display device, e.g., an LCD (liquid crystal display), LED (light emitting diode) display, or OLED (organic light emitting diode) display, for displaying information to the user.

Examples of input devices include a keyboard, cursor control devices (e.g., a mouse or a trackball), a microphone, a scanner, and so forth, wherein the user can provide input to the computer. Other kinds of devices can be used to provide for interaction with a user as well; for example, feedback provided to the user can be in any form of sensory feedback, e.g., visual feedback, auditory feedback, or tactile feedback; and input from the user can be received in any form, including acoustic, speech, or tactile input. Examples of output devices include a display device (e.g., a monitor or projector), speakers, a printer, a network card, and so forth. Display devices may include display devices that provide visual information, this information typically may be logically and/or physically organized as an array of pixels. In addition, a computer can interact with a user by sending documents to and receiving documents from a device that is used by the user; for example, by sending web pages to a web browser on a user's client device in response to requests received from the web browser.

An interface controller may also be included that may comprise any of a variety of known or future software programs for providing input and output interfaces. For example, interfaces may include what are generally referred to as “Graphical User Interfaces” (often referred to as GUI's) that provide one or more graphical representations to a user. Interfaces are typically enabled to accept user inputs using means of selection or input known to those of ordinary skill in the related art. In some implementations, the interface may be a touch screen that can be used to display information and receive input from a user. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft® Windows Powershell that employs object-oriented type programming architectures such as the Microsoft®.NET framework.

Those of ordinary skill in the related art will appreciate that interfaces may include one or more GUI's, CLI's or a combination thereof. A processor may include a commercially available processor such as a Celeron, Core, or Pentium processor made by Intel Corporation®, a SPARC processor made by Sun Microsystems®, an Athlon, Sempron, Phenom, or Opteron processor made by AMD Corporation®, or it may be one of other processors that are or will become available. Some embodiments of a processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related field will appreciate that a processor may be configured in what is generally referred to as 32 or 64 bit architectures, or other architectural configurations now known or that may be developed in the future.

A processor typically executes an operating system, which may be, for example, a Windows type operating system from the Microsoft Corporation®; the Mac OS X operating system from Apple Computer Corp.®; a Unix® or Linux®-type operating system available from many vendors or what is referred to as an open source; another or a future operating system; or some combination thereof. An operating system interfaces with firmware and hardware in a well-known manner, and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, and communication control and related services, all in accordance with known techniques.

Connecting components may be properly termed as computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

The present invention may comprise or implement a neural network for machine learning tasks. The neural network may be stored, trained, and/or executed entirely on the user's computer, partly on the user's computer, as a stand-alone software package, partly on the user's computer and partly on a remote computer or entirely on the remote computer or server. The neural network may be stored in the form of program code, as described above. The neural network, in some embodiments, may be a perceptron neural network, a feed forward neural network, a multilayer perceptron neural network, a convolutional neural network, a radial basis functional neural network, a recurrent neural network, a long short-term memory neural network, a sequence-to-sequence neural network model, a modular neural network, or the like.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A system (2000) for analyzing an environment comprising one or more objects, one or more properties, or a combination thereof, through multiple sensing modalities, the system (2000) comprising:
a) one or more sensor composites (140, 141, 142), each sensor composite (400) comprising:
i) a dome base (1010);
ii) a plurality of sensor primitives (1000) integrated into the dome base (1010), each sensor configured to generate a data stream based on the environment, wherein a plurality of sensing directions of the plurality of sensor primitives (1000) comprises a plurality of different directions, wherein the plurality of sensor primitives (1000) comprise a plurality of sensor types; and
b) a computing system (201, 112) communicatively coupled to the one or more sensor composites (140, 141, 142), comprising a processor configured to execute computer-readable instructions, and a memory component operatively coupled to the processor, comprising:
i) a machine learning model configured to accept a plurality of input data streams and generate a single operational health assessment of the environment as output, wherein the machine learning model is trained by a plurality of training data streams comprising one or more training data streams representing each sensor type of the plurality of sensor types; and
ii) computer-readable instructions for:
A) accepting, from the plurality of sensor primitives (1000), the plurality of data streams;
B) inputting the plurality of data streams into the machine learning model; and
C) generating, from the machine learning model, the single operational health assessment of the environment.

2. The system (2000) of claim 1, wherein the plurality of sensor types comprise visible sensors, thermal sensors, short-wave infrared sensors, long-wave infrared sensors, acoustic sensors, pressure sensors, temperature sensors, humidity sensors, range sensors, vibration sensors, or a combination thereof.

3. The system (2000) of claim 2, wherein the plurality of sensor primitives (1000) comprise one or more planar sensors comprising curved optical components such that spherical aberrations of each data stream of the one or more planar sensors are automatically corrected.

4. The system (2000) of claim 3, wherein the memory component further comprises instructions for stitching the plurality of data streams into a combined data stream.

5. The system (2000) of claim 4, wherein the machine learning model is further configured to accept the combined data stream as input and generate the single operational health assessment of the environment as output.

6. The system (2000) of claim 1, wherein inputting the plurality of data streams into the machine learning model comprises individually inputting each data stream of the plurality of data streams into the machine learning model.

7. The system (2000) of claim 1, wherein each sensor composite of the one or more sensor composites (140, 141, 142) further comprises an impedance matching interface (1040) operatively coupled to each sensor element of the plurality of sensor primitives (1000), configured to individually control an energy transfer to each sensor primitive of the plurality of sensor primitives (1000).

8. The system (2000) of claim 1, wherein each sensor primitive of the one or more sensor composites (140, 141, 142) further comprises a digitizer component (1050) operatively coupled to each sensor element of the sensor primitive (1000) and the CPU for Device Interface (1080), configured to accept a raw output and digitize each raw output into the data stream.

9. The system (2000) of claim 1, wherein the computing system (201,112) comprises a personal computing device, a portable computing device, a cloud server, or a combination thereof.

10. The system (2000) of claim 1, wherein the computer-readable instructions further comprise generating, based on the single operational health assessment of the environment, a proposed action plan for improving health of the environment.

11. The system (2000) of claim 10, wherein the proposed action plan comprises a timeline, concerns of improving the health of the environment, a breakdown of issues per object, costs of replacement or repair, existing commitments, resources, domains of coordinated action, conditions of satisfaction, and options for adjusting the proposed action plan.

12. The system (2000) of claim 1, wherein, for each sensor composite (400) of the one or more sensor composites (140, 141, 142), the plurality of sensor primitives (1000) are further configured to compress the plurality of data streams before transmitting to the computing system (1030, 201, 112).

13. The system (2000) of claim 1, wherein the computer-readable instructions further comprise mapping the plurality of data streams onto an industrial protocol register space.

14. The system (2000) of claim 1, wherein the one or more sensor composites (140, 141, 142) are operatively coupled to each other in a daisy chain configuration.

15. The system (2000) of claim 1, wherein the one or more sensor composites (140, 141, 142) are communicatively coupled to the computing system (1030) by a wired connection, a wireless connection, a network connection, or a combination thereof.

16. The system (2000) of claim 1, wherein at least one of the plurality of data streams comprises a heat distribution map indicative of wear and tear of the environment.

17. The system (2000) of claim 1, wherein the computing system (1030, 201, 112) further comprises a mobile device integration module comprising computer-readable instructions for:
a) receiving environmental image data from a portable computing device configured to generate images of an environment;
b) identifying one or more industrial equipment configurations in the environmental image data; and
c) generating one or more automated sensor placement recommendations based on the one or more industrial equipment configurations.

18. The system (2000) of claim 17, wherein the mobile device integration module further comprises computer-readable instructions for:
a) recognizing one or more equipment types based on the one or more industrial equipment configurations using computer vision algorithms;
b) accessing one or more equipment databases comprising failure statistics, thermal characteristics, or a combination thereof for each equipment type of the one or more equipment types;
c) identifying one or more critical monitoring points based on the failure statistics, the thermal characteristics, or the combination thereof for each equipment type of the one or more equipment types; and
d) optimizing the one or more automated sensor placement recommendations to maximize coverage of the one or more critical monitoring points.

19. The system (2000) of claim 1, wherein the computing system (1030, 201, 112, 121, 131) further comprises a synthetic data generation module comprising computer-readable instructions for:
a) generating one or more simulated sensor data streams based on the data stream, wherein the data stream comprises one or more equipment characteristics, one or more operational parameters, or a combination thereof;
b) generating one or more interactive demonstrations of system capabilities based on the one or more simulated sensor data streams; and
c) providing one or more customer engagement tools for system evaluation prior to purchase of equipment.

20. The system (2000) of claim 19, wherein the synthetic data generation module further comprises computer-readable instructions for simulating thermal imagery, temperature readings, acoustic signatures, vibration patterns, or a combination thereof corresponding to normal operational states, degraded equipment conditions, failure scenarios, or a combination thereof.

21. A method for automated industrial monitoring system deployment comprising:
a) capturing environmental data of an industrial site using a portable computing device;
b) processing the environmental data to identify, for one or more equipment modules, a location and a configuration;
c) automatically generating one or more optimal sensor placement recommendations based on the location and the configuration of the one or more equipment modules;
d) creating one or more synthetic sensor data streams for demonstration purposes; and
e) generating one or more automated proposals comprising system specifications and cost analyses relative to the one or more equipment modules.

22. The method of claim 21, further comprising optimizing sensor placement based on line-of-sight requirements, thermal monitoring coverage areas, accessibility for maintenance, power supply requirements, communication network topology, or a combination thereof.
